(19) United States
(12) Patent Application Publication
(10) Pub. No.: US 2006/0136325 A1
(43) Pub. Date: Jun. 22, 2006

(54) Automated proxy bidding

(76) Inventors: Richard Barry, Plano, TX (US); Daniel Cobb, Flower Mound, TX (US); Steven Nowick, Plano, TX (US)

Correspondence Address: CARSTENS & CAHOON, LLP, P O BOX 802334, DALLAS, TX, 75380, US

(21) Appl. No.: 11/173,831

(22) Filed: Jul. 1, 2005

Related U.S. Application Data
(60) Provisional application No. 60/638,151, filed on Dec. 21, 2004.

(51) Int. Cl. G06Q 40/00

(52) U.S. Cl. 705/37

(57) ABSTRACT

The present invention provides a method, program and system for automated proxy bidding in an auction. The invention includes defining a desired price position relative to competing bids based on qualitative ratings associated with competing bidders and submitting a bid related to a product. Competing bids are retrieved along with the qualitative ratings associated with each competing bidder, and a determination is made as to whether the submitted bid achieves the desired price position relative to the competing bids. If the submitted bid does not achieve the desired price position relative to the competing bids, the bid is adjusted according to a predefined sequence of price moves. The desired price position might have a specified premium relative to competing bidders with lower qualitative ratings and a specified discount relative to competing bidders with comparable and higher qualitative ratings.

### CROSS-REFERENCE TO RELATED APPLICATION

This application claims the benefit of and priority to a U.S. Provisional Patent Application No. 60/638,151 filed Dec. 21, 2004, the technical disclosure of which is hereby incorporated herein by reference.

The present application is related to co-pending U.S. patent application Ser. No. ______ (Client Docket No. ACOMM.0101) entitled “Reverse Auction With Qualitative Discrimination” filed even date herewith; co-pending U.S. patent application Ser. No. ______ (Client Docket No. ACOMM.0102) entitled “Method for Determining Single Figure of Merit” filed even date herewith; and co-pending U.S. patent application Ser. No. ______ (Client Docket No. ACOMM.0104) entitled “Semi-Blind, Multi-Round Bidding” filed even date herewith. The content of the above mentioned commonly assigned, co-pending U.S. Patent applications are hereby incorporated herein by reference for all purposes.

### TECHNICAL FIELD

The present invention relates generally to online auction and procurement systems, and more specifically to an automated proxy bidding system for a reverse auction in which sellers can evaluate competing bidders based on qualitative parameters in addition to price bids.

### BACKGROUND OF THE INVENTION

Online auctions have been growing in popularity for several years. Most of this auction activity has involved consumer products, purchased by consumers, where the sellers are either businesses or other consumers. However, business-to-business auctions have begun to catch on and represent a growing segment of the online auction business.

Most business-to-business auctions are for procurement and take the form of reverse auctions, wherein sellers of goods and services bid against each other to fulfill a requirement that a prospective customer has put up for auction (either themselves or using a facilitator). On-line auctions offer the promise of significant efficiencies for both buyers and sellers. Sellers can access demand at a relatively low cost (due to the auction channel's efficiency) and buyers can obtain bids from a multiplicity of potential suppliers at minimal investment in time.

To date, however, the utility of these business-to-business procurement auctions has been limited due to the constraint of the relatively one-dimensional auction format (where the only consideration is price) places on the sale of non-commodity products and, in particular, services. In typical business procurement, price is but one of several dimensions the customer must consider in making a purchase decision. The other considerations may be quality, vendor reliability, delivery, warranty, post-purchase support, contract terms, etc.

When an auction is conducted where the bids are heterogeneous relative to these other dimensions, the singular focus of the traditional auction (price) can become misleading. The lowest bid may or may not be “the best deal” in the terms the customer might define it, once the customer has given full consideration to the non-price attributes.

One clear limitation in the standard reverse auction is that is that price is the sole determination without regard to qualitative components. This limitation applies to both buyers and sellers. Utilizing the purchase of telecommunications services as an example, a small business owner that requires an exceptionally high level of reliability in service might not want to choose the lowest bidding carrier if that carrier has lower quality service or a relatively high risk of service disruption. At the same time, a bidder may want to have other information about a prospective buyer (beyond just his requirement), particularly if fulfilling the requirement involves the provision of services over an extended period. For example, a large provider of telecommunications services might decide not to bid aggressively if the customer is small and located in a remote area where the provider's cost of providing service is high. That bidder may also want to know something about the other bidders, to know whether they should meet a competitive bid, or rely on the superiority of their offer to justify a higher price. If both buyer and seller must do considerable research in order to participate effectively in the auction (as in the case of the carrier) or to consider other bidder attributes beyond the bid price (in the case of the buyer), much of the efficiency of the auction format is lost. In fact, this format may be poorly suited to the procurement in question.

Even price itself may not be one-dimensional. Continuing with telecommunications example utilized above, the typical telecommunication service proposal is a complex, multi-part combination of up-front charges, fixed monthly recurring charges, variable monthly recurring charges, minimum monthly charges, time-phased or volume-based discounts, and taxes and fees. This may be further complicated by the fact that each telecommunications supplier may have different capabilities and constraints in how they can bill for service, and therefore how they can bid on that business. As a result, the basic structure of pricing and its component details may vary from vendor to vendor, and they may choose to discount their services in very different ways. For example, while one service provider may be able to offer and bill for an 8% discount in their monthly service charge, another's billing system might not allow them to do so. That supplier might respond by offering a free month of service (which in a 12-month contract is roughly equivalent to an 8% discount), an alternative his billing system can accommodate.

The normal result of this “competitive creativity” is that the customer receives a number of competitive bids, each with a fundamentally different pricing structure. The customer is then forced to analyze the different structures and attempt to determine which bid is truly the best bid. Rather than comparing “apples to apples”, the customer is often forced to compare apples to oranges to bananas. This is frequently a difficult analysis (particularly across multiple locations and services), and may be beyond the capability (or patience) of many customers.

Furthermore, auctions that are determined solely by the lowest bid price are subject to “sniping”. Sniping is an auction tactic wherein a bidder watches competitive bids unfold and then, moments before the close of the auction, submits a bid that is only pennies better than the then-leading bidder. If the bid leader fails to, or is unable to, react in time, the “sniper” wins the auction. The prevalence of sniping on popular consumer auction web sites has led to a general bidding environment where 90%+ of the bidding action takes place in the final minutes of the auction. This result is undesirable for several reasons. Because so much of the bid action is compressed into the last few minutes, competitive bidding does not fully unfold, resulting in sellers (in the case of forward auctions) and buyers (in reverse auctions) receiving deals that are not as good as they might have been had competitive bidding fully developed. Winning snipers only best the leading bid by a small margin—in some cases, only a penny. With many bidders attempting to bid at the last possible moment, the system may be flooded with submissions as the auction is closing, and valid bids may not be entered into evaluation. From the standpoint of business-to-business reverse auctions, last-second bidding may discourage some bidders from even participating if revisions to their bid require management approval (which limits their ability to react to a last minute “snipe”). Fewer bidders mean less competition.

As a result of all of the aforementioned difficulties, the development of effective business-to-business reverse auctions has been limited to two ends of a spectrum. At one end, these auctions are popular for pure commodity products. If the product is a true commodity (such as rock salt), an auction where price is the only consideration is still useful. At the other end of the spectrum, reverse auctions have found a niche for the procurement of certain types of very complex, very expensive systems. In these cases, a significant effort is invested in the structuring of a Request for Bids so that bids must be presented in a way that facilitates straightforward comparison, and then considerable effort is devoted to analyzing and “scoring” these proposals against a complex set of evaluation criteria. Vendors compete on the scores achieved (rather than simply upon their price), and attempt to improve their proposal over several rounds in ways that will improve their score relative to the competitors. While this overcomes some of the drawbacks already detailed, its usefulness is limited to large companies and complex procurements that justify the effort on the part of all concerned.

Therefore, it would be desirable to have a procurement system that:
Allows both buyers and sellers in a reverse auction to evaluate each other based on qualitative parameters in addition to price
Is tolerant of products or services whose prices have multiple components that may differ across competitors
Maintains the competitive bidding advantages of a reverse auction while systematically eliminating the effectiveness of “sniping” tactics.
Is sufficiently automated and cost-effective to ensure the efficiencies of the auction process are not negated by “participation costs”, and therefore make the process practical and useful to smaller customers.

### SUMMARY OF THE INVENTION

The present invention provides a method, program and system for automated proxy bidding in an auction. The invention includes defining a desired price position relative to competing bids based on qualitative ratings associated with competing bidders and submitting a bid related to a product. Competing bids are retrieved along with the qualitative ratings associated with each competing bidder, and a determination is made as to whether the submitted bid achieves the desired price position relative to the competing bids. If the submitted bid does not achieve the desired price position relative to the competing bids, the bid is adjusted according to a predefined sequence of price moves.

This predefined sequence of price moves defines specifically what changes are to be made to each individual price element of the product in question and is modified according to specific customer characteristics. More price moves might be used for customers with more favorable characteristics according to predefined standards, whereas less price moves are used for customers with less favorable characteristics according to predefined standards.

The desired price position might have a specified premium relative to competing bidders with lower qualitative ratings and a specified discount relative to competing bidders with comparable and higher qualitative ratings.

### BRIEF DESCRIPTION OF THE DRAWINGS

The novel features believed characteristic of the invention are set forth in the appended claims. The invention itself, however, as well as a preferred mode of use, further objects and advantages thereof, will best be understood by reference to the following detailed description of an illustrative embodiment when read in conjunction with the accompanying drawings, wherein:

FIG. 1 is a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram illustrating a data processing system in which the present invention may be implemented;

FIG. 4 is a flowchart illustrating the process of obtaining projected cost saving estimates in accordance with the present invention;

FIG. 5 is a flowchart illustrating the procurement process in accordance with the present invention;

FIG. 6 is a flowchart illustrating the process used by the “Feature Wizard” in formulating service feature recommendations;

FIG. 7 illustrates a matrix presenting one such analysis for customers seeking a simple combination of local telephone lines and long distance minutes;

FIG. 8 is a flowchart illustrating the process of reducing various product price structures to a single figure of merit in accordance with the present invention;

FIG. 9 depicts an example matrix of specific pricing element used in developing projected contract costs;

FIG. 10 is a flowchart illustrating the process of establishing customer value preferences for the interactive auction phase of the procurement process;

FIG. 11 shows an example of a bid adjustment matrix;

FIG. 12 shows an example of an alternatives table;

FIG. 13 is a flowchart illustrating the process of sending Invitations to Bid to service carriers;

FIG. 14 is a flowchart illustrating the process of manual bidding in a reverse auction;

FIG. 15 is a flowchart illustrating the process of proxy bidding in a reverse auction; and

FIGS. 16A and 16B show screen shots of an ongoing reverse auction for telecommunications services in accordance with the present invention.

### DETAILED DESCRIPTION OF THE DRAWINGS

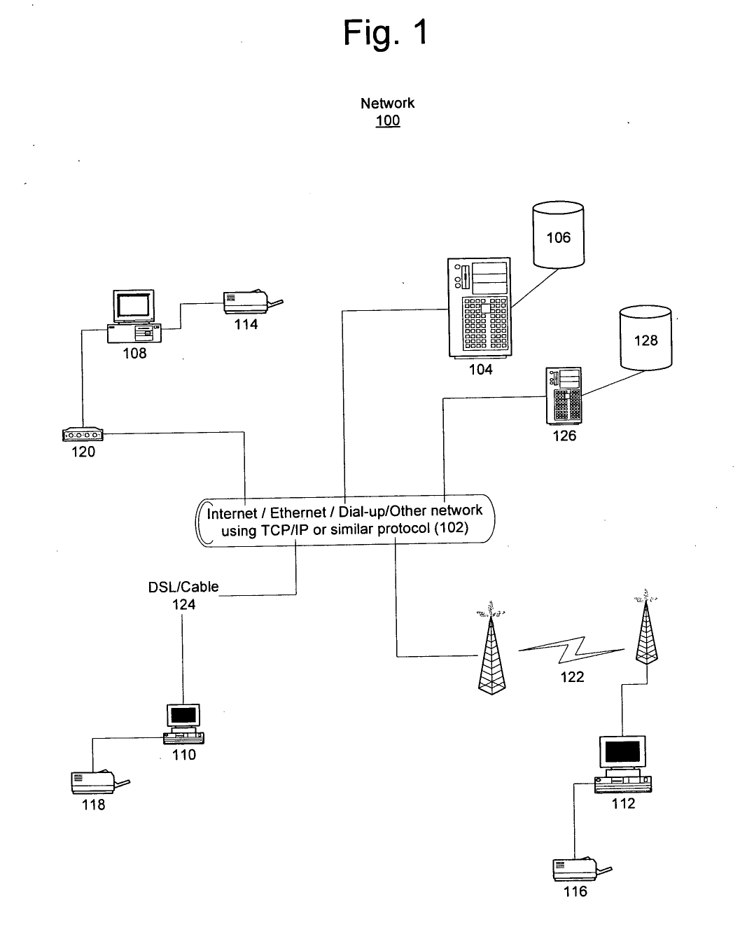

With reference now to the figures, FIG. 1 is a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, a server 104 is connected to network 102 along with storage unit 106. In addition, clients 108, 110, and 112 also are connected to network 102. These clients 108, 110, and 112 may be, for example, personal computers or network computers. In the depicted example, server 104 provides data, such as boot files, operating system images, and applications to clients 108-112. Network data processing system 100 might also contain a supplementary server 126 and additional data storage 128.

Clients 108, 110, and 112 are clients to server 104. Network data processing system 100 includes printers 114, 116, and 118, and may also include additional servers, clients, and other devices not shown. The means by which clients 108-112 connect to the network 102 may include conventional telephone landline (dial-up) 120, broadband Digital Service Line (DSL) or cable 124, or wireless communication network 122.

In the depicted example, network data processing system 100 is the Internet with network 102 representing a worldwide collection of networks and gateways that use the TCP/IP suite or similar protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

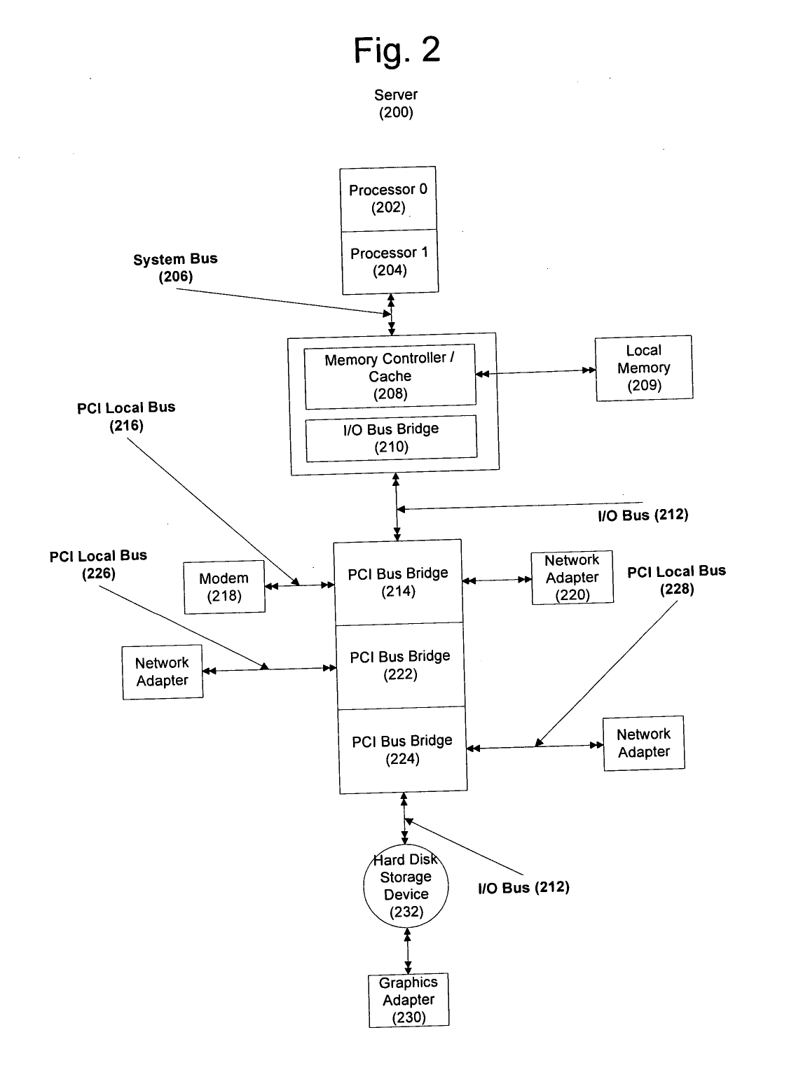

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communication links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an eServer pSeries system, a product of International Business Machines Corporation in Armonk, N.Y., running the Advanced Interactive Executive (AIX) or Linux operating systems.

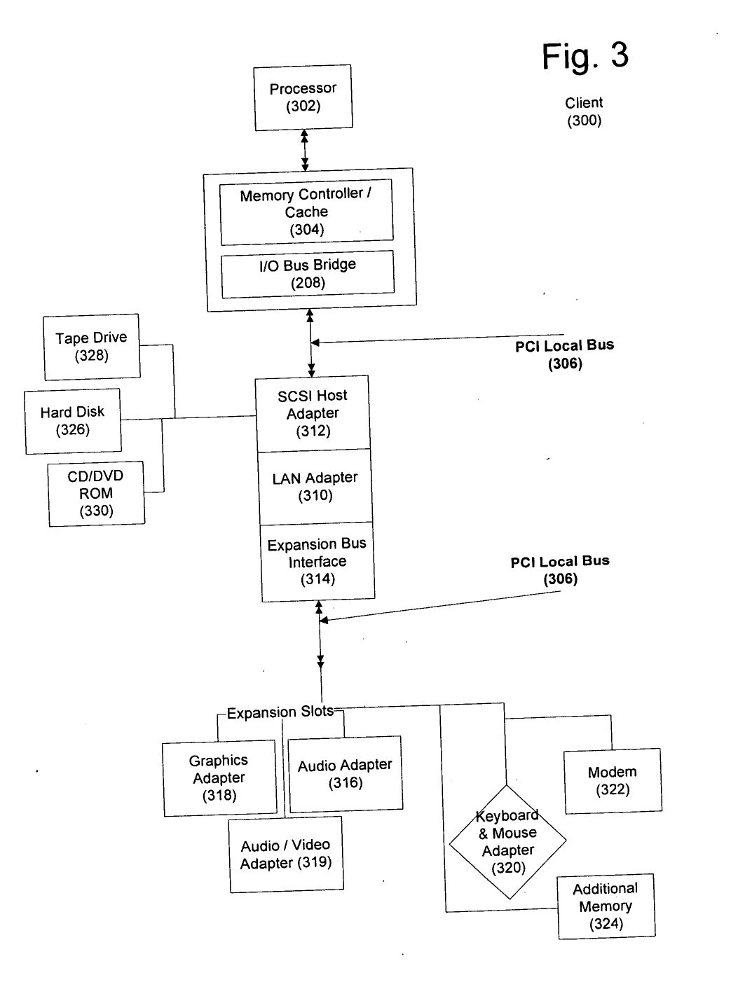

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD/DVD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and the above-described examples are not meant to imply architectural limitations. For example, data processing system 300 also may be a notebook computer or hand-held computer in addition to taking the form of a PDA. Data processing system 300 also may be a kiosk or a Web appliance.

The reverse auction system of the present invention comprises four main components:
A web-based customer interface with tools to help customers:
   Define their requirements
   Structure them for auction-based procurement
   View the results of auctions for their requirements
   Conduct related research
A database of carrier products, features, pricing and availability.
An auction engine that implements a “three-dimensional” auction scheme.
A web-based carrier interface with tools to allow carriers to:
   Input and maintain their individual entries in the database
   Submit bids in active auctions
   Enter and maintain their proxy bidding strategies for each product using proxy bidding

The discussion below will use the example of a reverse auction-based procurement for telecommunications services. However, the present invention can easily be applied to the procurement of other services, such as deregulated electricity, employee benefits plans, business insurance, Yellow Pages advertising, public accounting services, or any number of analogous business services.

When the customer arrives at the web site, he or she is offered a choice of five activities:
Conduct research into specific vendors or service offerings, using research and analysis available on the site.
Obtain a Quick Savings Estimate (QSE) to learn what previous customers with similar characteristics have saved using this method of procurement. In the case of first-time customers, because knowledge of the customer's requirements is limited at this time, the savings estimate is presented as a range (e.g., 5-10% or 15-20%).
Obtain a Tailored Savings Estimate (TSE), based on more detailed profile information provided by the customer through responses to questions. With this greater level of knowledge regarding the customer's current configuration and usage, the system can provide an estimate of anticipated savings within a much tighter range (e.g., 11-13% or 6-8%).
Obtain specific recommendations on the optimal configuration of telecommunications services for the customer's needs.
Initiate a service procurement using the reverse auction process.

The research features represent the organization and indexing of publicly available information and analysis, and are completely independent of the core auction system (although they utilize the same web-based customer interface).

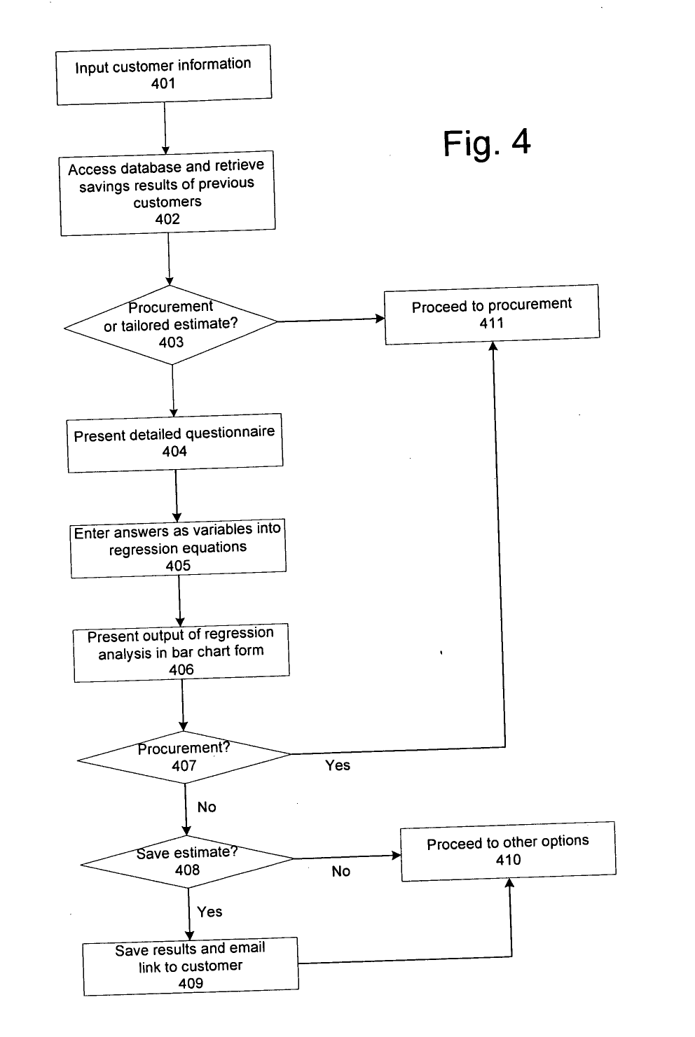

Referring to FIG. 4, a flowchart illustrates the process of obtaining projected cost saving estimates in accordance with the present invention. Customers desiring a Quick Savings Estimate input five pieces of information into the system (step 401):
Which telecom services they currently use (by service category)
How much the customer spends monthly, in total, for these services
Their current service providers for these services (who are then mapped into categories by their pricing tendencies)
The industry classification of their business (chosen from about 40 SIC codes)
Their number of employees

The system then accesses the database of auction results (including the associated customer profiles and savings achieved) and extracts savings results for the last 100 customers with a similar profile (as regards the 5 characteristics the customer has provided) (step 402). These results are presented to the customer in real time in the form of a histogram showing magnitude of monthly savings in percent across the horizontal axis and frequency of occurrence on the vertical axis. With this presentation, the customer can see both the savings provided on average, as well as the range of savings achieved across the entire sample.

At this point, the customer is asked whether he would like to proceed to procurement, or obtain a Tailored Savings Estimate, more accurately reflecting his specific situation (step 403).

If the customer opts for a tailored savings estimate, the system presents a questionnaire requesting more specific profile data (Step 404). These data may include, for example:
Greater detail on the nature of the business, including the specific number of locations at which they have telecom service(s).
A short profile of the telecom services currently utilized, by service category and business location, identifying:
   Number of telephone lines in service
   Key features utilized (e.g., voice mail, caller ID, etc.)
   Monthly volume of long distance minutes (across all telephone and facsimile lines), broken into “local toll”, intrastate, interstate and international calling categories
   Type of internet access and internet access speed
   Average monthly spending for each category of service
An inventory of current service providers, and the approximate date at which they contracted for each service. The vendor name (mapped to a category by pricing tendency) and contracting date allow the system to estimate the rates being paid by the customer.

The customer's answers to this multi-part questionnaire are imported to a functional module within the system where they are entered as variables in a series of regression equations that predict the spending levels achievable post-auction and derive the associated savings (step 405). These regression equations are developed by analysis of recent auction results data (together with the associated customer characteristics and pre-auction service spending), and the application of stepwise regression techniques that continually enhance the equations' use of the available data to improve the “goodness of fit”.

The output of these regression analyses is presented to the customer in the form of a bar chart showing predicted aggregate spending post-auction in comparison to the customer's stated pre-auction spending, and highlighting the projected monthly savings, the associated savings percentage, and the annualized value of predicted savings in dollars (or appropriate currency) (step 406). The accuracy of the savings estimate is communicated by the indication of an expected range of savings, normally with a margin of 2%.

At this point, the customer is once again asked if they would like to proceed to procurement (step 407). If the customer declines to initiate procurement, the system asks the customer if he would like to save the Tailored Savings Estimate, and prompts him to enter an email address (step 408). If the customer enters an email address, the tailored savings estimate is saved under that identifier, and the customer is emailed a copy of the results with an embedded URL that will enable them to return to the saved results at some future date (step 409). Savings estimates may be maintained for a specified period (e.g., 30 days), after which they are erased.

The customer may then choose another option (e.g., log off, move to the research section, or explore other portions of the site) (step 410).

Should the customer elect to initiate procurement (step 411), the data already provided constitute the majority of information the customer needs to provide to set up the procurement. The questionnaire answers provided above are carried forward and the customer is asked to answer only a few additional questions.

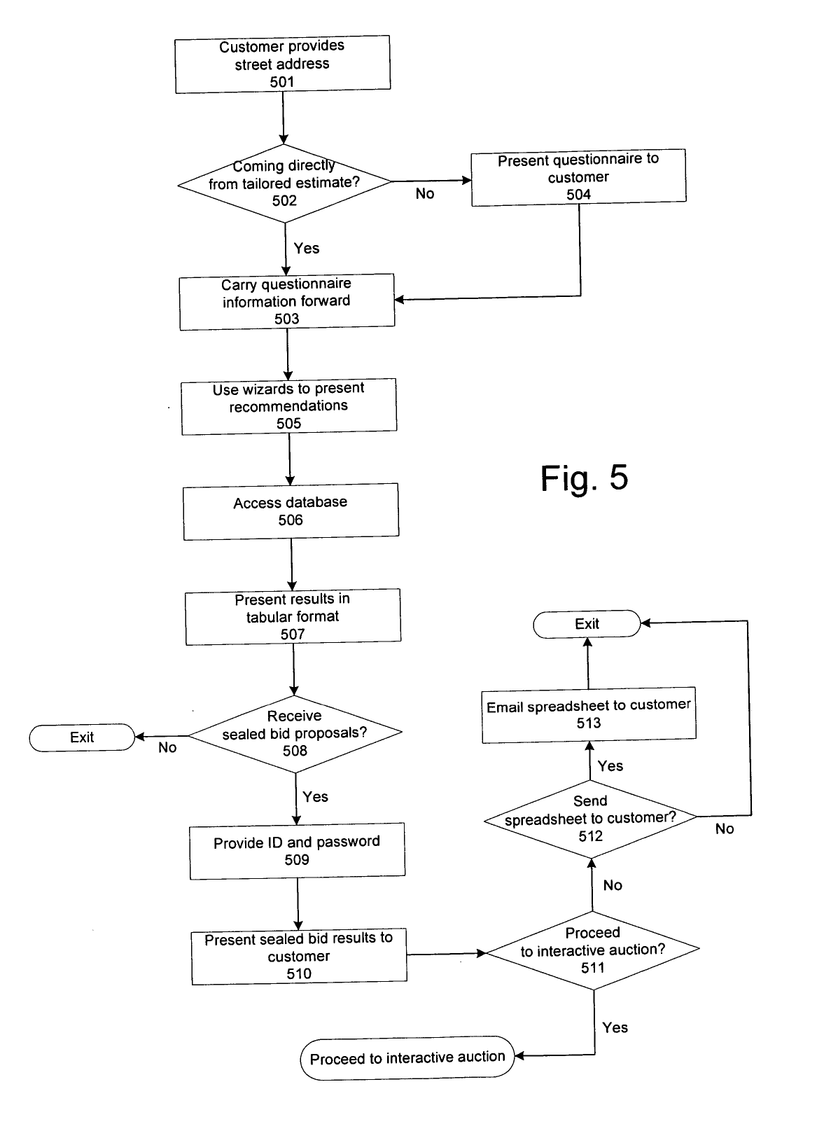

FIG. 5 is a flowchart illustrating the procurement process in accordance with the present invention. Once the customer elects to initiate procurement, the customer (who has been completely anonymous thus far) provides a precise street address or general business telephone number (although not an office or suite number, and no other personal information such as name, title or contact information) (step 501). A valid customer address or telephone number is necessary to verify the availability of certain telecom services at that location, as well as to determine which service providers are capable of providing the services requested. Location may also be necessary for services other than telecommunications. For example, some health insurance providers may not cover certain regions of the country, or specific Yellow Pages directories may not cover the customer's geography.

The system then determines if the customer is coming directly from the Tailored Saving Estimate process illustrated in FIG. 4 (step 502), and if so, the answers previously provided in the questionnaire are carried forward (step 503). If the customer enters the procurement process from another portion of the web site, and has not completed the detailed information questionnaire, the full questionnaire is presented to the customer at this time (step 504).

Before undertaking the process of developing recommendations for the customer's optimal service configuration, the customer is prompted to identify any incremental service requirements desired (such as additional telephone lines, features or the addition of internet access). Once these have been recorded, the customer is asked to confirm the requirements the system will consider, and once confirmation is received, the optimum service configuration development process begins.

The system employs a set of seven “wizards” that provide the customer with specific recommendations on the services and/or service configurations that will best satisfy the requirements presented (step 505). These service recommendations encompass:
The appropriate combination of “a la carte” features and “feature packages” (discounted bundles of features) on their telephone lines to fulfill their feature requirements at minimum cost.
Internet access speed and capacity.
Optimum contract term.
The optimal approach to procuring their requirements (e.g., a single auction for a bundled service requirement; multiple auctions for individual services; a single auction for an “integrated access product”)
   Broadly speaking, the wizards fall into one of three categories or types:
Truly intelligent recommenders: These recommenders apply analytical techniques to the determination of optimal solutions to customers' needs. For example, given a customer-specified feature set, what specific combination of feature “packages” and “a la carte” feature purchases satisfies the need at lowest recurring monthly charge?
Three-dimensional table lookups: These recommenders take specific customer needs, coupled with their responses to certain questions, and “look up” a preferred solution in a three-dimensional table that is based upon analysis of certain carrier data, or auction results, or both. For example, what is the “best” contract term for a specific customer, given typical discounts for term commitments, overall market price trends, and the customer's growth rate and willingness to switch providers?
Simple “intelligent questionnaires”: These recommenders walk customers through a complex series of questions in order to facilitate their specification of a requirement. The “intelligent questionnaire” knows when to prevent customers from specifying redundant or mutually exclusive requirements and knows when to drop entire series of questions, based on an initial customer response.
   Several of the wizards are hybrids of two or more of these basic types.

The first wizard is the “feature wizard”, which helps customers select which telephony features they want on each of the local phone lines they are purchasing. The wizard then determines what combination of feature purchases and package purchases minimizes the monthly recurring cost of satisfying the customer's feature demands, given the pricing for these features individually (“a la carte”) and as “feature packages” (bundles of features available at a discount). This is a truly intelligent recommender that uses linear programming techniques to determine an optimal solution.

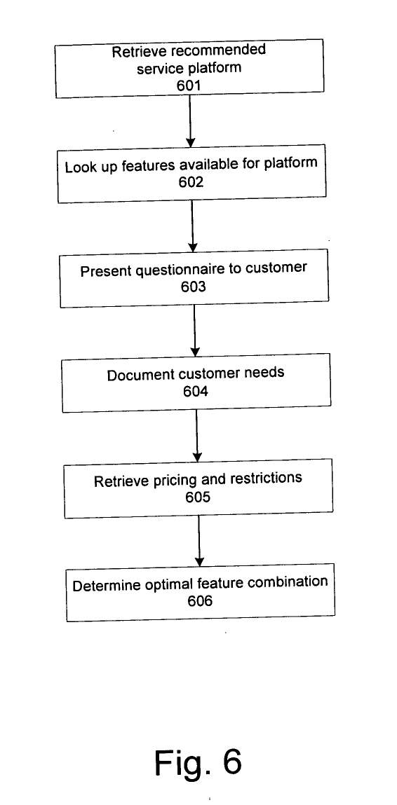

FIG. 6 is a flowchart illustrating the process used by the “Feature Wizard” in formulating service feature recommendations. The first step is to retrieve the basic service platform recommended for the customer (step 601). A “service platform” can be an integrated access line, or a DSL line, or local telephone lines purchased individually. The feature wizard looks up, in the carrier database, the individual features generally available with this service platform (step 602).

The wizard organizes (on the fly) and presents an intelligent questionnaire to the customer, leading him/her through the feature specification process (step 603). (Example questions may include: Do you want voice mail? Do you know what it is? If not, here is an explanation. Here is how much it generally costs. For which lines do you want this feature?) The feature wizard documents the customer needs resulting from this questionnaire process, typically as a matrix of lines versus features, specifying which features are desired on each line (step 604).

It then retrieves, on an eligible carrier by eligible carrier basis, the a la carte list pricing for these features, available feature packages, the pricing of those packages and the restrictions/requirements on individual features and packages (e.g., to order the “remote access to voice mail” feature, one must order the voice mail feature as well) (step 605). The wizard then applies a linear programming technique to the “customer need matrix” and the carrier-specific feature data to determine, in the case of that specific carrier, what combination of a la carte and package purchases satisfies the need at lowest recurring monthly charge (step 606).

The second wizard is the “internet speed wizard”, which helps the customer determine what speed and capacity to specify for direct internet access service. The internet speed wizard is, in essence, a 3-dimensional table lookup, using three inputs provided by the customer:
A “ping test”, which determines the customer's current effective internet access speed.
The customer's reaction to a Macromedia Flash demonstration of browser page loads at various simulated access speeds. The customer selects the simulation that most closely approximates the speed he generally wants his internet access to deliver.
Answers to a series of questions regarding:
   The number of people accessing the internet from this location.
   The applications generally used (e.g., email, file transfers, internet videoconferencing, etc.).
   The estimated average number of simultaneous users.

In varying combinations, the internet speed wizard utilizes these answers to determine the volume and nature of the offered load, the performance desired and the speed upgrade required. The wizard then queries a database to determine the alternative internet access services available at the customer's specified location, and selects the service type, speed and capacity that will best satisfy the estimated requirement.

The third wizard is the “contract term wizard”. This wizard recommends to the customer which contract term (for term-based services) will best suit the customer's situation. Generally, contract terms available range from one to five years. Some services may also be available on a non-contract, month-to-month basis (which offers no price protection). The contract term wizard is a three-dimensional lookup table that utilizes four pieces of data to make its recommendations:
A table of “average discounts for term” across the carriers participating in the marketplace (i.e. average saving over list price by committing to each of a one, two, three or five-year contract).
The auction service's own analysis and projection of what the average rate of market price change will be over the next 3 to 5 years (i.e. what is estimated to happen to the general level of prices in the marketplace? If the customer enters a contract one year from now, will prices be 10% higher? 8% lower?).
The customer's expected growth rate of telecommunications consumption (i.e. how much do they expect their line usage and minute volume to grow next year?).
The customer's general willingness to change suppliers. Do they consider switching from one supplier to another to be a significant inconvenience?

The first two pieces of data are the result of analysis performed by the auction service staff. Taken together, they are used to produce “standard contract term recommendations” by service category, derived from comparing the average discount for term to the expected market price changes. For example, if internet access rates are decreasing 8% per year, and a three-year contractual commitment offers a 15% discount, the optimal contract term may be one year.

The contract term wizard then adjusts the standard recommendation based upon the customer's expected growth rate and willingness to switch. High growth rates (which make the customer a larger prospect over time) favor a shorter contract. An aversion to switching may favor a longer contract, if the foregone opportunity from re-bidding is not too great. The auction service utilizes its business judgment in each service category to create a three-dimensional table of recommended terms as they vary by growth rate and willingness to switch. The wizard retrieves a specific recommendation from this table and presents it to the customer.

The fourth wizard is the “intelligent service recommender” (ISR). The ISR takes the customer's high-level requirements (number of local lines, volume and mix of long distance minutes and internet access speed requirements) and runs them through a two-step process to:
First, recommend the service platform or platforms the customer should use; and
Second, recommend the best “packaging” of that requirement or requirements for auction (i.e. which packaging is most likely to yield the lowest price auction result? Should all requirements be put up for bid in a single auction? Should they be broken into multiple auctions? If so, how?).

To develop the first recommendation (which service platform is best?), analysts study Sealed Bid prices in the carrier database (on a geographic market by geographic market basis) to determine, for each combination of lines, minutes and internet access speed, what service platform solution generally yields the lowest recurring monthly cost. This is a “best solution” in general, because the best solution for each and every carrier may not be identical. The analysts apply their judgment to determine the “crossover points” where one type of service platform becomes more economical than another (e.g., when should you fulfill your local line requirement with individual line purchases, and when should you step up to an “integrated access” solution (which bundles multiple “virtual” individual lines onto a single high-capacity line)? When is it better to increase your DSL speed, and when is it better to step up to a dedicated internet access T1?). These “zones of advantage” for specific service platforms and the crossover points between them are captured in a three-dimensional matrix that recommends the “best general solution” for any specific combination of lines, minutes and internet speed. (Note: If a specific recommendation is sub-optimal for a particular carrier, they are able to substitute an alternative once an auction begins. However, the change is flagged for the customer—indicating the various product solutions are “mostly apples-to apples” but include one “orange”).

Analysts also study auction outcomes to determine where they may alter the financial analysis above. For example, is price competition in specific service categories so intense that the auction outcomes alter the calculated crossover points? When does combining two or more requirements into a single competitive auction result in lower prices than purchasing those requirements in separate auctions? Alternatively, when does bundling things together (such as local phone service and internet access) result in higher costs? These “auction efficiencies and inefficiencies” may lead to a recommendation to always bundle specific requirements together for auction, or to always keep them separate.

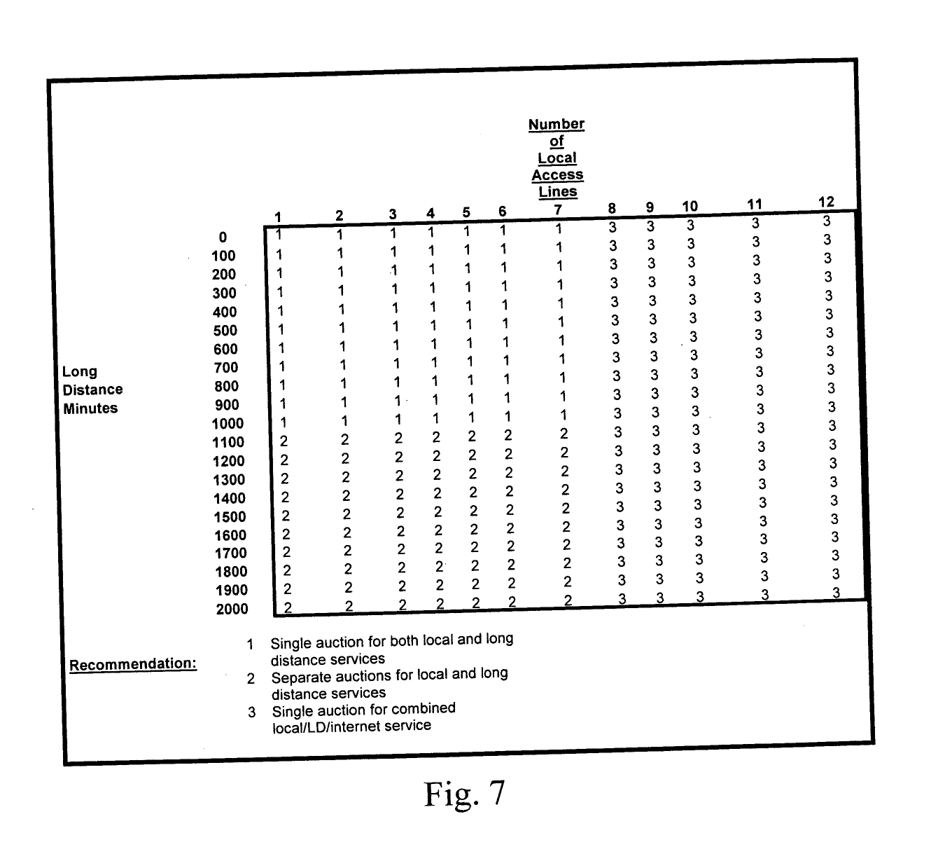

FIG. 7 illustrates a matrix presenting one such analysis for customers seeking a simple combination of local telephone lines and long distance minutes, without any requirement for internet access.

The ISR will then consider the customer's requirements profile and retrieve from this matrix both the recommended service platform or platforms and the optimal procurement strategy.

The fifth wizard is the “internet feature wizard”. This is largely an intelligent questionnaire that walks the customer through the specification of features associated with his or her internet access service:
It looks up in the carrier database the individual features generally available with the internet access service platform recommended (e.g., dial-up, DSL, cable, dedicated T1, etc.). These features would typically include email service and related options, off-site dial access, web hosting and domain name-related services.
It organizes (on the fly) and presents an intelligent questionnaire to the customer leading him through the feature specification process (Do you want web hosting? Do you know what it is? If not, here is an explanation. Here is how much it generally costs. Which of these hosting options is best suited to your requirement?). Its only “calculation intelligence” is associated with recommending aggregate email storage capacity (again, based on the customer's answers to a specific set of questions), if the customer is interested in email service.
It documents the customer need resulting from this process, typically as a matrix of lines versus features, specifying which features are desired on each internet access line or account.

The sixth wizard is the “long distance minute wizard”, which assists customers in specifying their volume of long distance minutes and the breakout of those minutes over relevant categories (intraLATA toll (or “local toll”), intrastate, interstate and international) through the following process:
If the customers know their average volume of minutes on a monthly basis, they are asked to enter it. If they do not know the volume of minutes (and most customers do not), they are asked to enter monthly spending in lieu of minutes. If they have the breakout of spending by local, intrastate/interstate and international, they enter it. If they have no breakout, they can enter aggregate spending and select a “calling profile” that generally represents their calling pattern (e.g., dominantly local caller, heavy intrastate caller, US-wide caller, heavy international caller). The wizard then imputes minutes by category (based on conversion tables developed by analysts), and presents the customer a breakout of minutes by category.
If the customer has either very high local toll calling volume, or very high international calling volume, the wizard will serve up specific questions that are key to assessing the customer's suitability for certain money-saving alternatives in these areas (which include various local calling plans and specific international calling plans). If the customer's answers indicate suitability for one or more of these options, the wizard will add that to the overall requirement (potentially revising other components of the requirements downwards) and determine whether the addition of these options alters the recommended optimal procurement strategy.

The seventh wizard is the “long distance features and options wizard” which is an intelligent questionnaire that, if specific long distance services are recommended, walks the customer through the selection and specification of certain long distance-related features that may be associated with that long distance platform (e.g., 800 service, calling cards, various call-blocking and billing options). Its operation is analogous to the wizard described for internet access features.

Results are then presented to the customer, including a “potential variance” looking at plan cost at one standard deviation plus or minus on usage. The customer reviews and/or researches this “short list” of alternatives and selects a specific plan.

Returning to FIG. 5, once the customer has completed the input, and the wizards have helped to define the detailed service recommendations, the system will access its database of carrier products, availability and pricing (step 506) to:
Identify the carriers capable of satisfying the specified requirement (based upon the services required and the carrier's service availability at the location specified)
Determine, on a vendor-by-vendor basis, the specific vendor services (or combinations of services) necessary to satisfy the customer requirement
Retrieve the list pricing appropriate to the specified configuration within that selected product or combination of products

These results are presented to the customer in tabular format, highlighting the potential choice among a plurality of two or more vendors, the specific vendor product(s) recommended, and summarizing list price information for those products (step 507).

The present invention allows the customer to access a profile of any listed vendor or product (by clicking on it), see list pricing detail, or compare any two vendors on a side-by-side basis across a number of topic areas, such as:
Vendor profiles (corporate-level profile)
The specific products in question
Contract terms and conditions (including service level commitments and remedies)
Networks and facilities
Customer service accessibility

This presentation also introduces the auction service's vendor rating system. This rating system rates each vendor's service quality on a 4-level rating scale (four stars being best) and rates the vendor's business risk (defined as the probability the vendor will suffer some form of financial event potentially impacting service) on a 3-level scale (three stars being best). These ratings are based upon objective third-party evaluation of each vendor, and are assigned by the system operator. The ratings themselves can be formulated by the third parties or by the auction service, based upon raw data supplied by third parties. Each vendor's rating is shown next to its name, and the customer can click on these ratings to see a further explanation of the rating system and the detailed vendor evaluations upon which the individual vendor ratings are based.

These types of ratings are specific to the implementation under discussion (telecommunications procurement), but could take other qualitative (or even quantitative) forms in other implementations. For example, in an implementation dealing with the procurement of employee health care plans, the two qualitative dimensions could relate to aspects of coverage under the competing plans (e.g., physician choice, procedures and treatments covered). In an implementation dealing with the procurement of Yellow Pages advertising, the two factors could be population coverage of a directory and the number of overlapping directories addressing the same population.

At the bottom of this presentation, the customer is asked if they would like to receive “sealed bid” proposals from these vendors (step 508). If the customer elects to proceed to the sealed bid stage, he is prompted by the system to provide both a user ID and a password to enable the sealed bids to be stored in a secure manner, and accessed solely by the customer (step 509). Except for having revealed a street address or general business telephone number, the customer is still otherwise anonymous at this stage.

Sealed Bids represent standard discounted opening offers—i.e. Manufacturer Suggested Retail Price (MSRP)—that are provided without interactive competition amongst the vendors. These sealed bids represent each bidders' first discounting move for the products specified and are retrieved by the system from the vendor product and pricing database (step 510). The Sealed Bid presentation format is generally similar to that used for the list price presentation, but introduces the approach to financial evaluations of bid proposals.

Since the typical telecom service proposal is a complex, multi-part combination of up-front charges, fixed monthly recurring charges, variable monthly recurring charges, minimum monthly charges (or, conversely, blocks of “free” usage), (potentially) time-phased or volume-based discounts and taxes and fees, and since the pricing structure and details may vary according to vendor, it is extremely difficult for the average customer to easily compare vendor proposals. This problem applies to other service areas that typically involve various combinations of charges such as utilities, health insurance, and other employee benefits.

The present invention eliminates this problem by using system-based algorithms to project the proposed pricing month-by-month over the term of the contract, using the bid proposal and the customer's prior input regarding required numbers of lines, desired features, minute usage, etc., and then utilizes a selected evaluation method algorithm to collapse the stream of projected charges into a single figure. This method reduces the vendors' financial proposals to a “single figure of merit”, which can be compared across vendors on an “apples-to-apples” basis.

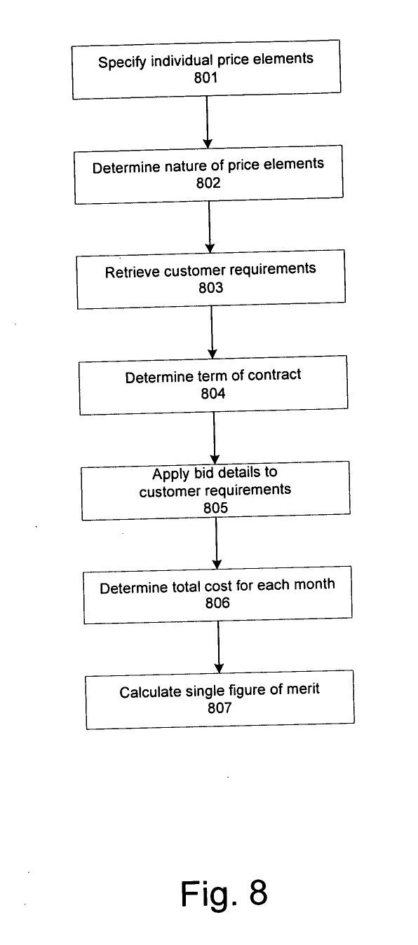

FIG. 8 is a flowchart illustrating the process of reducing various product price structures to a single figure of merit in accordance with the present invention. The process takes the myriad individual price elements and combinations “as bid” and converts them to a single financial figure that can be compared across bidders.

The process begins by specifying the individual price elements in a bidder's detailed bid (step 801) and determining the nature of those price elements (step 802). This is accomplished by designating the nature of each price element as the carrier enters it into the system, or fills out the manual pricing form. For example, the characteristics of price elements in a telecommunications service bid might include:
One-time charges to be applied in the first month of the contract, if any.
Recurring, fixed monthly charges that will be billed as presented every month (e.g., the $24.95 per month basic service charge).
Variable monthly charges and what the variation is based upon (e.g., number of lines, number of minutes, type of minutes, etc.).
Charges with both a fixed and variable element (e.g., $34.95 for 1000 minutes of service, and then $0.03/minute for every minute over).
Volume-related discounts (e.g. $24.95 each for the first 5 lines, then $21.95 each for the next 5, and $19.95 each for everything over 10).

After determining the characteristics of the individual bid elements, the system retrieves the customer's inputs regarding service requirements (step 803). In the case of telecommunications, this information may include number of lines, number of minutes by type, usage of specific features, the allocation of those features across lines, etc.

The system next determines the proposed term of the contract in question (step 804). This factor affects both the number of months projected and cost averages, as well as the prices carriers will bid in the first place.

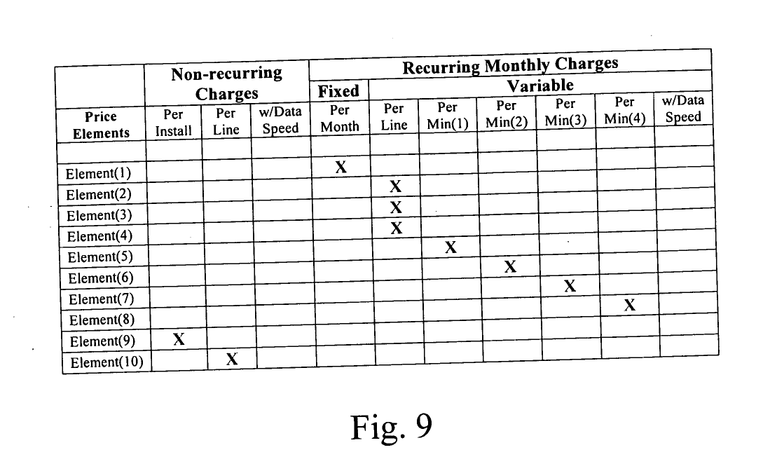

FIG. 9 depicts an example matrix wherein the system is instructed as to how to treat each specific pricing element (element(1) through element(10) in the attached example) when it is developing the 1, 2 or 3 year projection of contract costs.

The system can then apply the bid details to the customer's specific requirements by multiplying each component of the customer's usage against the right bid price element and lay it out over the right number of months (step 805). All the elements in each month of the projection are added together to determine a total cost for each month (or relevant time unit) (step 806).

Once the correct stream of monthly charges is determined, the system applies (in the present implementation) one of four pre-selected system-based algorithms to reduce that stream of charges to a “single figure of merit” (step 807):
If the algorithm is “average per month”, the system simply adds all of the payments together and divides by the number of months in the contract term to derive the average charge per month.
If the algorithm is “first 12 month's spend”, the system adds the first 12 months charges together and presents the total.
If the algorithm is “total contract spend”, all the monthly charges over the term of the contract are added together and the total is presented.
If the algorithm is for Net Present Value (NPV), the system applies a NPV function to the stream of monthly payments, using a monthly discount factor specified by the system operator (e.g., 0.5%).

The net result of this process is the production of a “single figure of merit” (SFOM) that applies to all of the bids submitted in the auction. While the results of all four algorithms are related, each accentuates a different aspect of interest in the bid proposals.

The SFOM concept has powerful benefits to the buyer in the auction setting, reducing heterogeneous, multi-component competitive bids down to individual, readily comparable numbers, enabling the buyer to comprehend auction results quickly and make decisions in real-time.

While the above example of the SFOM concept applies to telecommunication services auctions, this innovation has applicability in other complex auction areas which defeat the traditional, simple “one-dimensional” reverse auction.

The telecommunications example above is part of the larger category of reverse auctions for product transactions wherein the product price has multiple elements that vary by bidder. By far, this is the most common form of reverse auction. However, an explanation is most easily illustrated using common forward auctions, such as those found on internet sites like eBay.

In a typical internet forward auction, the buyer's purchase cost has four distinct elements:
1) The bid price on the product itself;
2) Shipping costs;
3) Seller-imposed “handling charges” related to shipping (such as packaging) or the buyer's basis of purchase (e.g., a surcharge for credit card-based purchases, or requiring use of a “buyer pays” auction payment service, such as BidPay, where the buyer is assessed a surcharge on the purchase price when they pay); and
4) Insurance charges

Auctions tend to focus exclusively on the first element, bid price. However, the remaining three can be material, and can differ significantly across various sellers. The somewhat singular focus on the bid price can mislead the buyer as to which “deal” is best. Consider the following example for the purchase of an identical commodity from two alternative sellers:

TABLE 1

| | Seller A | Seller B |
|---|---|---|
| Winning bid price | $4.95 | $9.95 |
| Seller “handling charges” | | |
| Package handling charge | 8.00 | 0.00 |
| Payment-related charges (eg, BidPay) | 1.00 | 0.00 |
| Shipping cost (UPS vs. USPS flat rate) | 10.50 | 7.00 |
| Insurance cost | 1.50 | Included in shipping |
| Buyer's “Total Landed Cost” | $25.95 | $16.95 |

While on the surface, purchasing from Seller A would appear to be a bargain (50% less!), application of the SFOM concept shows that, in fact, purchasing from Seller B saves 33%.

While the SFOM concept would be difficult to implement in a forward auction (where the bidder/buyers drive much of this cost variability by where they live, how they want things shipped, how they choose to pay and whether or not they want insurance) and the seller accepts the bid, it would be both practicable and highly valuable in any reverse auction process (where differences amongst potential sellers would drive most of the above variability) and the buyer is making the bid decision.

Another area to which the SFOM concept is highly applicable involves reverse auctions where “Life Cycle Costs” are the principal consideration. Life Cycle Cost (LCC) is a well-established purchase evaluation concept that focuses the procurement decision on the total cost of operation of a product over its intended life, rather than simply upon its up-front purchase cost. Components of LCC for a typical industrial product might include:
Up-front purchase price
Savings associated with seller-provided discount financing (relative to the buyer's own cost of capital)
Fuel consumption, power or other operating costs
Expected maintenance or extended warranty costs
Consumables required for operation
Labor costs (wages and training costs)
Useful life
Residual or resale value

Like the example in Table 1, a product whose up-front purchase price is low may have significant disadvantages in these other LCC areas, leading a buyer to conclude that a second product with a higher up-front purchase price is in fact a better deal over its expected operating life.

Table 2 illustrates the example of procurement of commercial aircraft:

TABLE 2

| | Boeing 767 | Airbus A300 |
|---|---|---|
| Initial purchase cost | $200 Million | $180 Million |
| Seller-provided financing | 3%, 15 years | 1%, 8 years |
| Operating cost/hour (fuel) | $7,500 per hour | $10,000 per hour |
| Required crew size | 7 (incl. 2 cockpit | 9 (incl. 3 cockpit |
| | crew) | crew) |
| Maintenance cost per year | 4% of purchase | 6% of purchase |
| | price P.A. | price P.A. |
| Expected useful life | 24 years | 20 years |
| Residual value (2005 $$) | $33 Million | $18 Million |
| Estimated Life Cycle Cost | $425 Million | $490 Million |
| LCC/Operating Hour | $18,500 | $24,500 |

In this example, the more expensive up-front purchase actually has the lower LCC over the life of the transaction.

In a reverse auction in this context, the appropriate SFOM might be total LCC or LCC per operating hour, where either of these is calculated by buyer-provided algorithms operating upon bid elements provided in each bidder's bid (e.g., what is their operating cost per hour, assuming aviation fuel costs $2.40 per gallon). Bids would then be ranked relative to these SFOMs and the ranking adjusted based on qualitative factors relevant to this type of purchase (e.g., commonality with the existing aircraft fleet and domestic labor offset in the operator's home country).

More typical applications of life cycle cost in a business procurement context might be purchase of automotive or commercial truck fleets, fork trucks, or energy-intensive industrial process equipment. In each of these transactions, most or all of the component costs from the aircraft example would be relevant to a life cycle cost-based decision.

Returning to FIG. 5, the sealed bids and bidders presented in step 510 are ranked in straight descending numerical order (“FIRST” through “nth”) using a “lead” evaluation method (i.e. single figure of merit such as NPV or average per month), without regard (at this stage) to the quality or risk associated with the bidders. While a single method is used to rank the bids, the results of all four evaluation methods are presented.

In addition, for the first time, this presentation includes a “Customer Savings Summary” showing the potential savings to the customer thus far. Savings are based on the average of the sealed bids versus the customer's declared current monthly spending, and are shown in both percentage terms and total annual dollar savings (or other currency). Using a methodology similar to that used to provide the “Quick Savings Estimate” described earlier, the system accesses the database of auction results and provides the customer with an estimate of how much further the vendor bids are likely to improve in a competitive interactive auction (the next phase of the procurement process), based on final outcomes for the last 100 similar auctions.

At this point the customer decides whether to proceed to an interactive auction, abandon or move to a different portion of the web site to research the proposals and vendors shown in the Sealed Bid presentation (step 511).

If the customer elects to depart, the system inquires if the customer would like to receive the sealed bid spreadsheet by email, and prompts the customer to provide an email address (step 512). If the customer complies, a copy of the results is emailed including a URL link to their sealed bid results and the system automatically generates a follow-up email in seven days, reminding the customer of the results and potential savings (step 513). Sealed bid results are saved for a specified period of time (e.g., 30 days), and then erased.

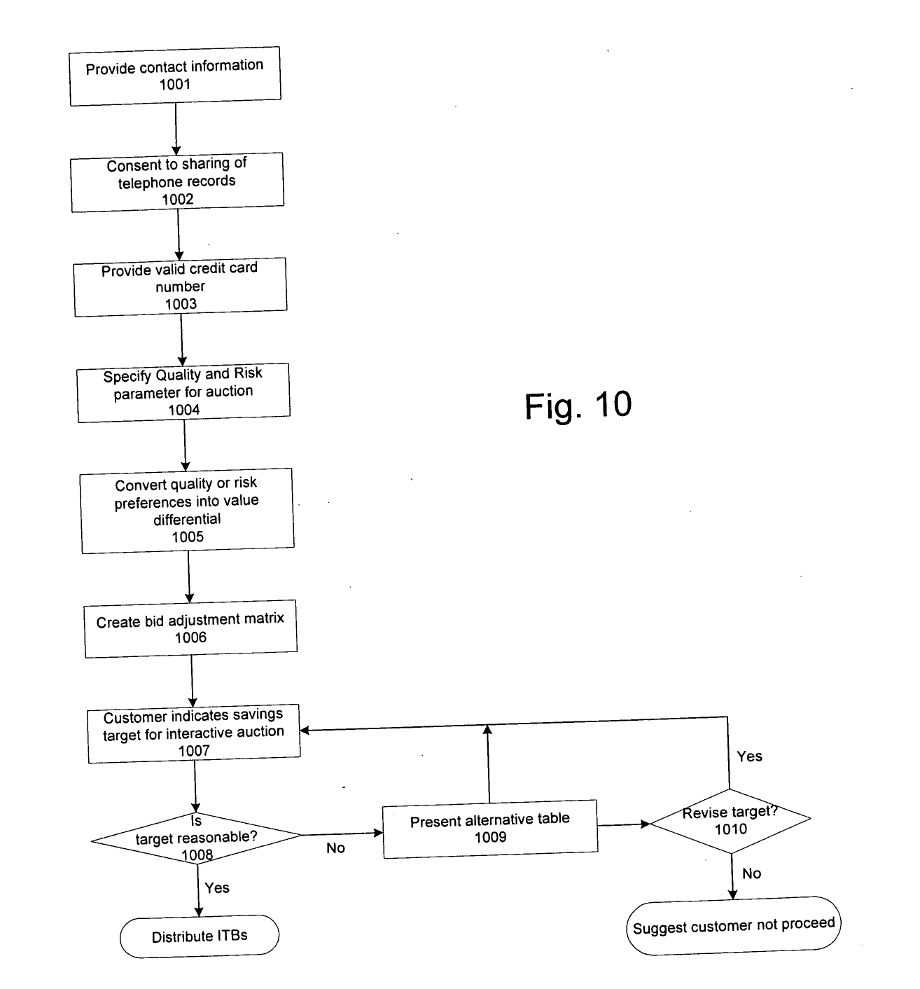

FIG. 10 is a flowchart illustrating the process of establishing several critical customer characteristics for the interactive auction phase of the procurement process. Once the customer elects to proceed to an interactive auction (where invited carriers will bid in real-time competition with one another), the customer completes several steps prior to auction commencement:
Provide contact information (i.e. name, title, business name, complete address (including suite or office number), telephone number and email address) (step 1001);
Consent to allow the system to retrieve the customer's telephone company records and consent to allow the auction service to share some or all of these data (at the service's discretion) with invited bidders (step 1002);
Provide a valid credit card number (step 1003) and authorize the service to use it;
Specify several important parameters for the conduct of the auction itself (step 1004), including:
   Accept or edit the proposed list of bidders (i.e. striking any bidders they wish to exclude from consideration)
   Select a preferred method of bid evaluation:
      Average cost per month
      Total spending over the contract term
      First twelve months' spending
      Net Present Value (NPV) or accept the default method of evaluation.
   Specify the quality and risk parameters they wish to apply to evaluation of the bidders
   Indicate a desired incremental savings target

At its core, the present invention's auction process differs from traditional one-dimensional reverse auctions (wherein price is the sole consideration) in that it considers several qualitative factors (i.e. service quality and risk, for example) in conjunction with price. With these additional factors taken into consideration, the auction becomes, from the customer's perspective, three-dimensional, simultaneously considering price, service quality, and risk/reliability. This implementation makes the auction implicitly value-based, with price, quality and risk together determining value as the customer defines it. To enable price, quality and risk to be considered in an integrated fashion requires that the customer define quality and risk preferences in a quantitative manner of some form.

In the present invention, the customer's specified quality parameter indicates, implicitly, the value placed on the quality of service provider by stating the premium the customer is willing to pay to procure from a vendor offering superior quality (or alternatively, the discount demanded before dealing with a provider whose service quality is inferior).

Similarly, the customer's specified risk parameter indicates the value placed on a completely stable source of supply by stating the premium they are willing to pay to deal with a vendor with a high probability of stable service provision (or alternatively, the discount demanded before accepting a greater risk of disruption).

The customer specifies these parameters in full knowledge of the impact they may have on cost of service, thus making a price-“value” tradeoff. The system elicits these responses via an interactive form that allows customers to input their preferences in terms with which they are comfortable. Customers can explore the manifestations of varying levels of quality or risk in terms meaningful to their anticipated use and see how these varying levels may affect both the number of vendors who may participate and their reasonable expectation of savings.

The system takes the customer's answers to the quality and risk questions, and in a two-step process, converts them into a pair of mathematical tables that will be used in the bid ranking process (explained in more detail below). In the first step, the single quality or risk figure input by the customer is converted by system algorithms into implied value differentials between all quality and risk rating levels (step 1005).

These differentials are then further manipulated by the system to create a “bid adjustment matrix” that allows any two bids from two competing bidders to be normalized for differences in service quality or risk—creating “relative bid values” (step 1006). These relative bid values can then be used for ranking the bids, one relative to the other. Once the bids are ranked on this value-adjusted basis, the “as bid” bids are shown to the customer in ranked order (the weighted, “normalized” bids exist only within the system for bid ranking purposes). The figures presented to the customer always represent prices at which he can purchase the service represented.

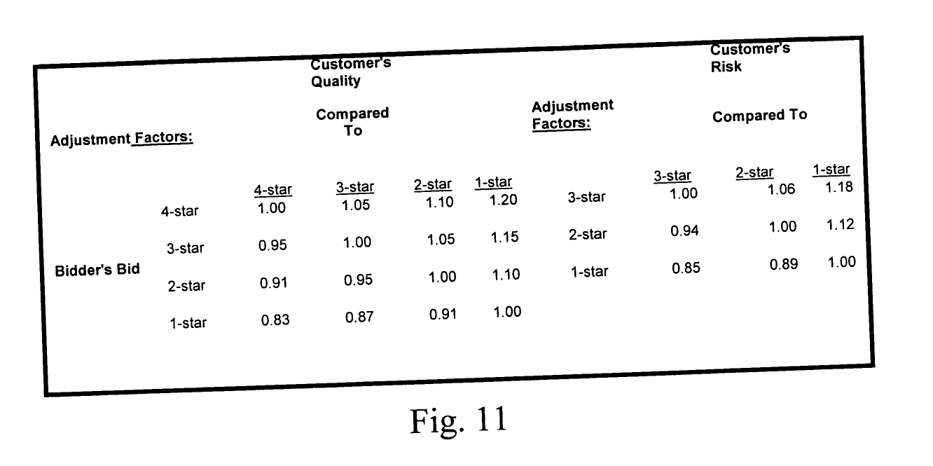

FIG. 11 shows an example of a bid adjustment matrix created in step 1006.

Once customers have input their personal quality and risk preferences, they are asked to indicate a savings target for their interactive auction—the percent improvement they wish to see between the Sealed Bid prices and the final results of the interactive auction (step 1007).

To ensure customers do not specify absurd or unrealistic targets, the system provides guidance as to a reasonable expectation for improvement given the quality and risk parameters they have indicated, and tests the reasonableness of the target they input (step 1008). If the target is “reasonable” (in light of prior experience with auctions of this specific type), the system acknowledges that “This Target Can Be Achieved”.

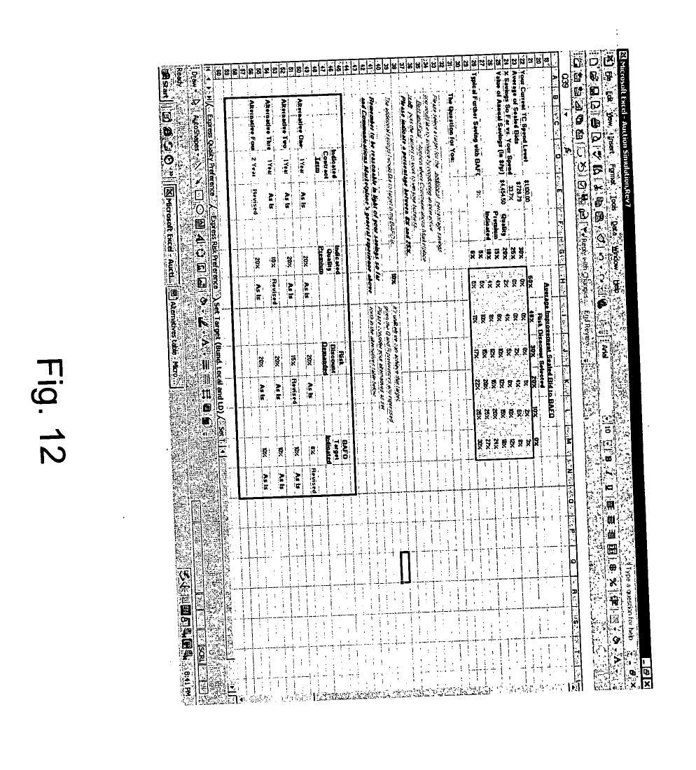

If the target is unreasonable, the system notifies the customer “This Target is Unlikely to be Met”, and presents the customer an “alternatives table” showing how the customer might vary one or more preferences (i.e. contract term, expressed quality preference, expressed risk preference or improvement target) to define an overall combination that is achievable (step 1009). FIG. 12 shows an example of an alternatives table. The customer then decides whether or not to revise his auction parameters (step 1010). If the customer is unwilling to alter the parameters specified, the system recommends the customer not proceed to an interactive auction, as the expectations are unlikely to be met.

The effect of stating (and, if necessary, massaging) this target is principally psychological: it is not disclosed to the bidders, and has no bearing on the evaluation of bids. It does, however, get customers thinking about the target at which they will be comfortable in committing to buy service. The customer is notified by email when this target is achieved during the course of the auction—creating another important milestone in preparing him to commit. This whole process allows the system to assure bidding vendors that customers undertaking an interactive auction are, indeed, ready and willing to buy.

In the current example of a telecommunications reverse auction, the qualitative factors are implicitly given equal weight in the adjustment of as-bid prices. This flows logically from the methodology used by the customer to establish the premiums utilized in the adjustments. Customers are asked what magnitude of premium they would pay to deal with a supplier of a certain Quality level (relative to what they would pay to suppliers of lesser quality), and what magnitude of discount (in essence, a negative premium) they would demand in order to deal with a supplier of a certain Risk level (relative to what they would pay to suppliers offering less risk). The relative importance of these two factors to the customer is implicit in the premiums they assign. In this case, there is no need to apply a relative weighting to the two qualitative discriminating factors to reflect their relative importance.

However, in other implementations, one could easily imagine an auction where the two qualitative discriminating factors are not of equal importance, and the methodology for determining their values does not implicitly account for their importance. For example, in the application of the present invention to the purchasing of industrial chemicals, the two qualitative factors considered (in addition to bid price) might be purity and currency risk (assuming some of the bids are non-US dollar denominated). Purity measurements might be in percentages (e.g., 98%, 99%, 99.5%), while currency risk might be assessed by determining the volatility of the currency in which a specific bid is denominated relative to the US dollar (in essence, a beta value). In this case, unlike the telecommunications case, the methodology of determining the value of the qualitative discriminating factors does not implicitly assign relative importance to the two factors. Instead, the values would be completely orthogonal.

This problem can be solved in two different ways. The customer evaluating the bids can develop conversion tables that map each measured value to a “score” which implicitly reflects the financial importance of that discriminating factor to the customer. The measured values would then each be translated, through their respective tables, into quantitative adjustment factors that implicitly reflect the relative importance of the two qualitative discriminating factors. In the example above, if within the expected ranges of purity, the penalty to the customer for lower purity is somewhat higher consumption of the chemical in question, varying purities might be “translated” into adjustment factors that are relatively small. By contrast, if currency swings could increase the cost of procurement by 20%, 30% or even 50% (particularly for deliveries that might occur in the future), the beta values on various bids might be translated into much larger adjustment factors.

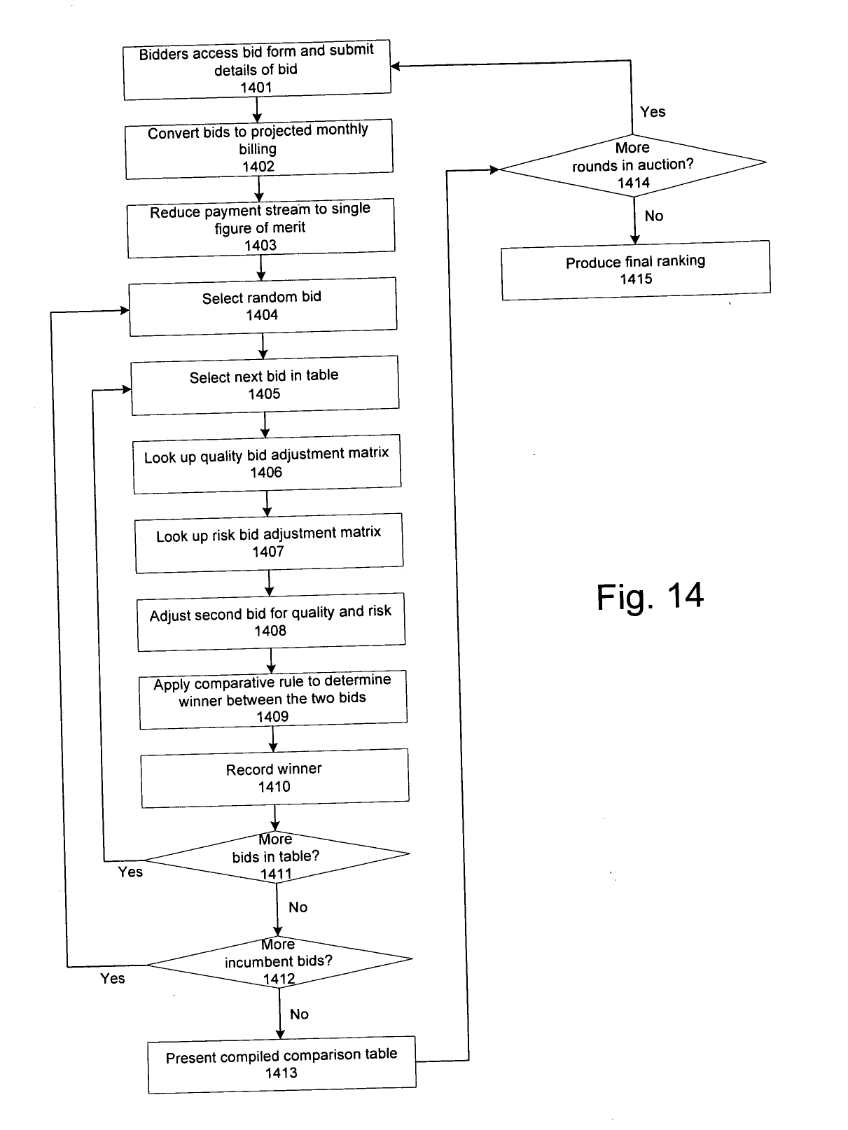

An alternative approach would be to provide the customer the opportunity to indicate the importance of one factor relative to the other directly, by indicating to the auction system that one discriminating factor is of primary importance and the other of secondary importance, or that the two were of equal importance. For example, a simple declaration that one discriminating factor is “primary” and the other “secondary” could invoke a pre-determined relative weighting scheme wherein the primary determinant score is increased by a pre-determined factor, and the secondary determinant score is decreased by the reciprocal of that factor. In an implementation wherein the pre-determined relative weighting scheme were to assign the primary factor twice the importance of the secondary one, the first score would be increased by 50% while the second is decreased by 50%. If the scores were 1.20 for the primary factor and 1.50 for the secondary, the following adjustment would apply under the COMBO rule described below in relation to FIG. 14:
Adjusted Value=As-Bid Value×((1.20−1.00)×1.5)+1.00)×((1.50−1.00)×0.5)+1.00)

A more flexible approach might ask the customer to “set a balance point” on a scale of 0 to 100, with factor 1 at one end and factor 2 at the other. If, for example, the customer sets the balance point at 50, the two factors would be weighted equally. If the customer set the balance point at 20, then factor 1 would be assigned a weight of 20 relative to factor 2's weighting of 80—implicitly stating that factor 2 is four times as important. This approach would result in the following adjustment, using the previous example and the COMBO rule described below:
Adjusted Value=As-Bid Value×((1.20−1.00)×0.25)+1.00)×((1.50−1.00)×4.0)+1.00)

Either method can be readily implemented as a feature of, or option within, the present invention.

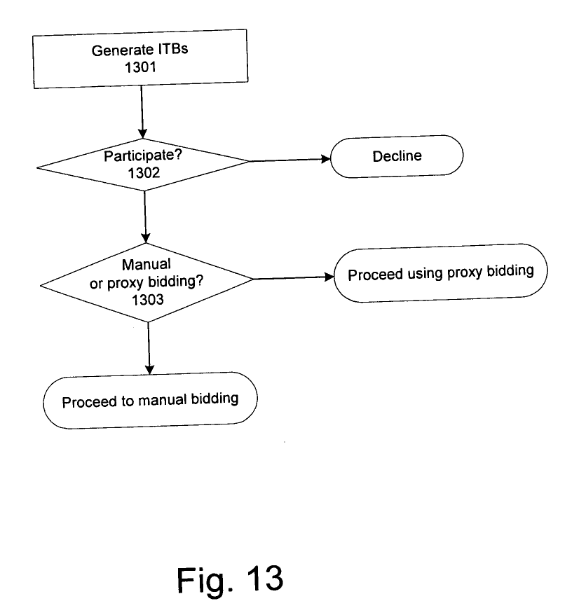

FIG. 13 is a flowchart illustrating the process of sending Invitations to Bid to service carriers. Once the customer has completed the tasks above, the system automatically generates and issues Invitations to Bid (ITBs) to a plurality of two or more carriers indicated on the customer's approved sealed bid list (step 1301). ITBs are deposited in “message waiting” boxes on the carrier side of the system, and can be viewed by authorized representatives of each carrier upon log in.

The Invitation to Bid, while maintaining the anonymity of the customer, provides critical bid-related information to the invited carriers. This information includes a detailed description of the customer requirements (such as number of lines, desired features, long distance usage, internet access speed, contract term, etc.), and the specific products presented to the customer in the List Price and Sealed Bid phases of the process (each carrier sees only the selection recommended from its product inventory). ITB information also includes the customer location (only at the level of detail necessary for the bidder to pre-qualify the customer for service; not the specific address), as well as critical customer characteristics including:
Total telecom spending
Industry (SIC) category
Dun & Bradstreet (D&B) rating
Location of the customer vis a vis relevant carrier facilities (i.e. will the customer be served from underutilized facilities; facilities at normal utilization; facilities which currently have extremely limited capacity available?)
Whether or not this customer is already a customer of the invited carrier (only the incumbent carrier sees this identification), and
Whether or not this customer has multiple related auctions underway, and if so, identifiers for the related auctions.

These secondary customer characteristics assist the would-be bidders in assessing the potential “value” of this customer to their network, and, therefore, assist in determining how aggressively they may want to bid for this particular customer.

Finally, the ITB provides details relevant to auction participation, such as a listing of the invited bidders, the auction “shell number” (i.e. identifier), start time, number of rounds, and closing times for each round.

The ITB does not provide the invited carriers with the customer's name, contact information, exact address, their identified quality and risk preferences or their auction target. One benefit to customers of this method of procurement is relative anonymity and the confidence that “no salesmen will call” as a byproduct of their participation.

All carriers participating within this electronic marketplace must submit certain information to the system operator, and then commit to keep that information up-to-date. This information includes:
Input to the system's database of carrier products and pricing for that subset of their product line they wish to make available in this marketplace
Electronic copies of the service contracts intended to be used with each of these services
Definition of the geographic availability of each service
Specification of a “sealed bid” price (separate from their “List Price”) for each service; and, if they are using the system's automated bidding facility,
All of the necessary inputs (described later) for the system's proxy bidding engine

The system provides carriers with various electronic forms and tools to enter this data, replicate it (if necessary) across geographic markets, and to implement updates to this data over time.

Upon receipt of an ITB, the carrier must decide whether or not to participate in the reverse auction (step 1302). If a carrier declines to participate, its name will disappear from the auction screen upon the close of the first round of bidding (the first point at which its participation would otherwise be missed). The non-participating carrier will be unable to see any information related to this auction as it unfolds. It will be unable to access the auction “shell”, and will receive no post-auction data relative to this procurement.

If the carrier does decide to participate in the reverse auction, it may choose between using manual bidding or automated “proxy” bidding (step 1303).

The interactive reverse auction of the present invention has a distinctive structure. The auction is completed in a fixed number of rounds (e.g., three), each of which is of fixed duration (however both the number and duration of rounds can be modified for an alternative implementation). Bidders may submit bids in a particular round at any time while that round is “open”. Once the round “closes”, further bids for that round are refused. Bidding is “semi-blind”, meaning each bidder can view the “as evaluated” bids (i.e. the single figure of merit results) and bid ranking for each previous round (starting with the Sealed Bid round). Bidders have no visibility into bids submitted within the current (open) round. No bidder names are associated with bids; bidders are identified only by the Quality and Risk Ratings assigned to them by the auction service. The bidders formulate their bids for each new round with reference to their competitive position in the preceding round and their instincts as to where bidding will go in the current round.

The relative anonymity of the bidders (since Quality and Risk ratings can be identical across a number of bidders) and the provision of “as evaluated” results (single figure of merit instead of specific bid details) provide participants with assurance that their specific pricing strategies will be difficult for competitors to discern over time, but still allows them to be aware of the nature of each bidder (i.e. their quality and risk ratings), so they can formulate their bidding strategy accordingly.

Bidders may submit multiple bids within a round, but, upon close of the round, only the best of the bids submitted (on an evaluated basis) will be utilized in the ranking. A bid may be withdrawn, in which case the system will evaluate the bidder's last valid bid (including the bid evaluated in the prior round, if none other is available in the current round).

Bidders may also elect to change the product they are bidding if they, in their expert opinion, consider another of their products to be suitable and to provide them with greater competitive advantage. Changes, however, will be flagged to the customer and indicate the bidding may no longer be “apples-to-apples” from a product standpoint.

The unique combination of a multi-round auction coupled with semi-blind bidding is designed to thwart the practice of “sniping” while still realizing the benefits of an interactive, competitive auction. Sniping is the auction tactic wherein a bidder watches competitive bids unfold and then, moments before the close of the auction, submits a bid that is only pennies better than the then-leading bidder. If the bid leader fails to, or is unable to, react in time, the “sniper” wins the auction. The prevalence of sniping on popular consumer auction web sites has led to a general bidding environment where 90%+ of the bidding action takes place in the final minutes of the auction. This result is undesirable for several reasons. Because so much of the bid action is compressed in the last few minutes, competitive bidding does not fully unfold, resulting in sellers (in the case of forward auctions) and buyers (in the case of reverse auctions) receiving deals that are not as good as they might have been had competitive bidding fully developed. Winning snipers only best the leading bid by a small margin—in some cases, only a penny. With many bidders attempting to bid at the last possible moment, the system may be flooded with submissions as the auction is closing, and valid bids may not be entered into evaluation. Additionally, last second bidding discourages bidders from participating if their counter, to be competitive, will require a management approval for which time will not be available. Fewer bidders mean less competition.

FIG. 14 is a flowchart illustrating the process of manual bidding in a reverse auction. If a carrier decides to participate utilizing manual bidding, it has been informed via the ITB as to when each round's bid is due. Manual bidders access a system-based electronic bid form, enter the details of their proposed bid, and submit the bid for evaluation in round currently open (step 1401). The form shows their bidding history (i.e. original list price bid, sealed bid, and interactive bids for each of the auction rounds completed thus far). The form specifies all of the price elements they must provide to submit a bid and the time remaining for bid submission in the current auction round. The electronic bid form also allows a bidder to trigger a preview evaluation of its proposed bid (although not a ranking) under the system's four evaluation methodologies. This allows bidders to see their bid in a form (the as-evaluated single figure of merit) comparable to the competitive bids submitted in the earlier rounds, enabling bidders to ensure their proposed changes at the detailed element level will have the impact they anticipate at the overall evaluation level.

The ability to formulate their bids at the detailed, component-price level and have them evaluated at the “single figure of merit” level has important benefits for participating carriers. The single largest restriction upon most carriers' ability to price is what they are able to bill. If their billing system cannot bill for a particular price innovation, then they cannot use it in the marketplace. For example, while some carriers are capable of billing an 8% discount on normal recurring monthly charges, another carrier's billing system might not allow such a discount. Therefore, that carrier might choose to respond by offering the customer free service (i.e. no monthly recurring charge) in month 12 of the contract, which is roughly equivalent to an 8% discount, an alternative his billing system might be able to accommodate.

In the prior art, the normal result of this “competitive creativity” is that the customer receives multiple competitive bids, each with a fundamentally different pricing structure. The customer is then forced to analyze the different structures and attempt to determine which bid is truly the best bid—on an “apples-to-apples” basis. This is frequently a difficult analysis (particularly across multiple locations and services), and may be beyond the capability (or patience) of many customers.

The two-tier bidding structure utilized by the present invention solves both problems. It allows each bidder to modify individual price elements, move-by-move, in ways they can subsequently bill while the customer sees bids ranked on a comparable “single figure of merit” basis, freeing them from having to understand the details of multiple competing bids (unless they choose to).

To aid in formulating their initial interactive bid, each participating bidder may access the tabular presentation of the Sealed Bids already shown to the customer, however, with certain specific information hidden. As stated earlier, bidders are identified only by their quality and risk ratings and unlike the customer, they cannot access bid details for any bid other than their own. All they see are the “single figure of merit” results of the four evaluation methodologies described above. However, as a practical matter, careful analysis of these results will allow a bidder to divine some characteristics of the details of other bidders' bids (for example, whether they appear to have waived up-front installation charges).

Once a round of the interactive auction closes, the system reviews the bids received, associating them with the bidders who generated them. Each multi-component bid is converted to its projected month-by-month billing over the term of the contract, utilizing the vendor's bid and the customer's prior inputs for number of lines to be ordered, associated features, minutes of long distance usage (by category: local toll, intrastate, interstate, international), etc., to calculate a projection of each component of the billing for each month (step 1402). The result is a stream of 12, 24 or 36 calculated monthly payments (assuming a 1, 2 or 3 year contract term), including whatever non-recurring charges are billed at the commencement of the contract.

This payment stream is then run through the preferred evaluation methodology selected by the customer (or the default methodology, if the customer expressed no preference) (step 1403). The algorithm underpinning the selected evaluation methodology reduces the payment stream to a “single figure of merit” (e.g., the NPV of the multi-component bid over the term of the contract).

Taking the “single figure of merit” that now represents each bidder's bid (or carrying forward a prior round bid, if no new bid was submitted) the system creates a table of the bids and begins the ranking process.

The system starts with a competitor bid selected at random (step 1404) and takes the next competitor's bid in the bid listing (step 1405). The system then looks up the quality adjustment factor in the customer's Quality “bid adjustment matrix” appropriate to the two bids under consideration (step 1406). For example, using the “bid adjustment matrix” shown in FIG. 11, if the starting bid was from a carrier with a 4-star quality rating, and the comparison bid was from a 3-star rated vendor, the system would select the adjustment factor in the first row, second column of the matrix (1.05).

The system then repeats this action for the Risk “bid adjustment matrix” (step 1407). Assuming the starting bid is from a carrier with a 3-star risk rating, and the comparison bid is from a 1-star rated vendor, the system would retrieve an adjustment factor of 1.18.

The system then adjusts the second of the two bids according to these factors, recording a quality-adjusted bid (the bid multiplied by 1.05), a risk-adjusted bid (the bid multiplied by 1.18), and a quality and risk-adjusted bid (the bid multiplied by 1.05×1.18) (step 1408).

The system applies one of three comparative rules (as directed by the system operator) to determine which bid is the winner between the two bids in question (step 1409). The first possible rule is the “OR” test, wherein the competing (second) bid must be lower than the “incumbent” (first, randomly selected) bid in unadjusted value and in either a quality-adjusted or risk-adjusted comparison. Otherwise, the incumbent bid wins. The second rule is the “AND” test, wherein the competing bid must be lower than the incumbent bid in unadjusted value as well as both a quality-adjusted and risk-adjusted comparison. The third possible rule is the “COMBO” test, wherein the competing bid must be lower in unadjusted value and in a compound quality/risk-adjusted comparison.

The selection of the comparison rule (the “OR”, “AND” or “COMBO” test) allows the system operator to determine the rigorousness of competition. Given how these tests function, the “OR” test is most favorable to “challengers”, and the “AND” test most favorable to “incumbents”. The “COMBO” test is an attempt to design a comparison rule that favors neither challenger nor incumbent.

The “WIN” or “LOSS” by the competing bid is recorded (step 1410), and the system then selects the next competitor's bid in the table (if any) (step 1411) and repeats the process. Ultimately, the system compares every competing bid against the first randomly selected incumbent bid and records a “WIN” or “LOSS” against every one of them.

When there are no more bids to compare to the first incumbent bid, the system then returns to step 1404 and randomly selects another “incumbent” bid from the remaining bids and repeats this process of comparing this bid to every competing bid, and so forth, until every bid has been compared against every other bid (step 1412).

The system has now built a table of the outcome of every comparison under the comparison rule selected. It can then determine the ranking of bids. The bid that has “WON” in every single comparison is ranked “FIRST”. The bid which has “WON” in every comparison save one is ranked “SECOND”, and so forth, until the last bid (which has “LOST” in every single comparison) is ranked last.

The system now compiles the comparison table for presentation to the customer (step 1413). The carriers are sorted in the order in which they have placed, and the unadjusted bids associated with each carrier are presented (the adjusted bid figures are completely internal to the system, and are seen by neither the customer nor the bidders). Since this ranking (in this implementation) is a value ranking, it is possible that a higher-ranked bid will be greater in dollar terms (or other currency) than a lower ranked bid if the higher-ranked bid has a quality and risk rating that justify the premium. Therefore, the ordinal ranking of bidders may deviate from the cardinal value of their bid prices. The system retrieves the “single figures of merit” associated with each bid under the other three evaluation schemes and places them in the appropriate column next to each carrier's bid.

Once the ranked results are posted, the clock begins on the next auction round (step 1414). At the conclusion of the specified number of rounds, bidding is closed, a final ranking is produced, and the customer is notified the final results are available for his review (step 1415).

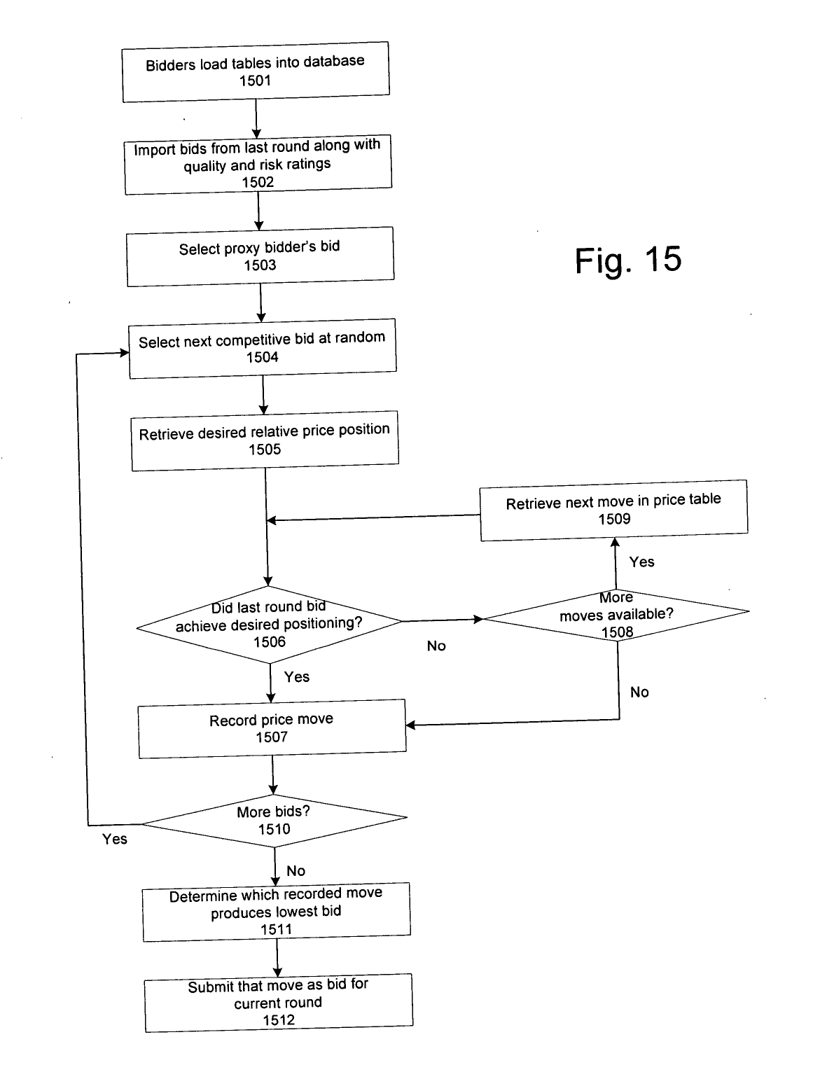

FIG. 15 is a flowchart illustrating the process of proxy bidding in a reverse auction. If a carrier, in response to an Invitation to Bid, elects to use automated bidding (or that is his standing practice), the bidder utilizes the system's proxy bidding engine. As the name implies, automated bidding allows the bidder to establish pre-determined pricing actions and set rules for invoking them in a competitive auction. To do so, for each product to be presented under proxy bidding, the carrier must load four tables into its secure portion of the system's database (step 1501) over and above the information necessary to support basic participation and manual bidding.

The first table is a definition of the “feature packs” associated with the service in question. This table shows the system what bundles of features are available on the specified service as an alternative to “a la carte” feature pricing; what the nature of each feature pack is (e.g., an “all included” package, a “3 for the price of 2” package, or a “pick any 4 from a list of 8” package, which instructs the bid engine how to evaluate each package); and, finally, what the price for the “feature pack” bundle is.

The second table is the approved sequence of price moves that defines specifically, with each move, what changes should be made to which elements of the carrier's pricing for the product in question (price element by price element, move by move). Each move in the sequence is identified (i.e., “list”, “sealed bid”, “Move 1”, “Move 2” . . . , “Last Move”) so status of the bidding can be reported to the carrier in simple terms as the auction progresses.

The third table is a “reaction to customer characteristics” table that defines desired alterations to the price move sequence when a customer exhibits certain specified characteristics (as disclosed in the ITB). These characteristics may include, e.g., designating this customer as an existing customer or as larger than a certain size, credit poorer than a specified D&B rating, location in a grossly underutilized carrier facility, etc. Upon recognition of the specified attribute, the system will follow instructions set forth in this table to start the relevant price move sequence at a different move, or stop it at a specified move, or both. For example, a carrier might define a sequence of 12 price moves, ultimately discounting its product up to 25%. It might, however, not want to exceed Move 7 (with an aggregate discount of 15%) in routine competition. However, if the customer in question is large, and will be served from an underutilized facility, the carrier can direct the system via this table to continue bidding up to Move 12 if necessary.

The fourth table is the “Trigger Matrix”, which defines the carrier's desired price position in competition relative to each different class of competitor (class being defined as a unique combination of Quality and Risk rating). For example, when competing against a competitor of similar characteristics (same Quality rating, same Risk rating), a bidder might want to price at a comparable level (i.e. zero discount or premium). Alternatively, when bidding against an inferior competitor (lower Quality rating, poorer Risk rating), the same carrier might want to price at a specific premium to that competitor. The carrier specifies its desired relative price position against every class of competitor in the Trigger Matrix.

Once the carriers have defined these four tables for a service made available in the system, they may utilize proxy bidding in any auction.

The proxy bidding engine starts by importing all of the bids from the last round (or in the case of the first round, from the Sealed Bid round), together with the Quality and Risk ratings associated with each bidder (step 1502). The engine selects the bid associated with the auction participant for whom it is bidding (step 1503), and then randomly selects another bid (Competitor 1) in the list (step 1504).

Based upon the Quality and Risk rating of this competitor bid, the engine retrieves the desired relative price position for its own bid from the trigger matrix (step 1505), and examines its participant's last round bid to determine if that move achieves the desired relative positioning against the competitor's bid in question (step 1506). For example, if the competitor's price is $100 NPV, and the desired price positioning against that class of competitor is a 10% premium, is the price move being examined equal to or less than $110 NPV?

If the prior round's bid has already achieved the desired relative position, the proxy bidding engine stops and records that price move (i.e. no change) as the desired price move against Competitor 1 (step 1507).

If that move does not achieve the desired position, the proxy bidding engine determines if there are more moves available in the relevant price table (step 1508). If there are more moves available, the proxy engine goes to the next price move in the table and applies the same test (step 1509). The proxy engine will continue testing moves until a price move achieves the desired price position against Competitor 1 or until there are no more price moves available. If the engine exhausts the available price moves without finding one which satisfies these tests, then it will submit the indicated “LAST MOVE” as the price move against Competitor 1.

The proxy engine then selects the next competitive bid (if any) (step 1510) and repeats the process using the relative price position appropriate to the Quality and Risk ratings of that competitor, ultimately recording the desired price move against Competitor 2. This continues until the proxy bidding engine has considered every competitive bid, and has identified which move delivers the desired price positioning against each competitor.

The engine then examines all of those “desired moves”, including its existing last round bid (because none of the moves in the current round may be the appropriate solution), and determines which of those moves results in the lowest price (step 1511). This price, by definition, will be equal to or less than the target relative price position against every competitor (i.e. it is the price which ensures none of its “relative pricing rules” will be broken). The proxy bidding engine submits this price move as its bid for the current round (step 1512). If the price table's “LAST MOVE” is the lowest of the bids under consideration, then it will submit the indicated “LAST MOVE”, and notify the bidder that it has exhausted the pre-determined price moves. This provides the bidder with the opportunity to review the bidding situation and decide to “stand pat”, or move to manual bidding in order to continue to compete.

In one embodiment of the present invention, price moves may also be determined by the auction round. The desired relative price position may be dynamic, wherein bidding becomes more aggressive toward the end of the auction. In this situation larger price moves are reserved for the last rounds of the auction.

This scheme is referred to as multi-dimensional determination of price moves under proxy bidding. Unlike a conventional reverse auction, wherein the bidder makes a single decision (“do I match or beat the leading bid?” regardless of its source), multi-dimensional determination emulates real-world pricing. In a real-world competitive situation, a bidder attempts to determine the bid that will position his price appropriately to the spectrum of competition, given their characteristics and his price strategy. That price may be above some competitive bids and below others.

However, under the present invention, the bid price reacts to actual competitive bids, not a salesperson's perception of where pricing is or the customer's representation of where pricing is. To that extent, multi-dimensional determination of price moves is “better” than its real world counterpart because it implements the same strategic price positioning but does so upon competitive price moves known with 100% certainty.

Once a recommended price move is submitted by the proxy bidding engine, it joins all other bids to be evaluated in the same manner as described above.

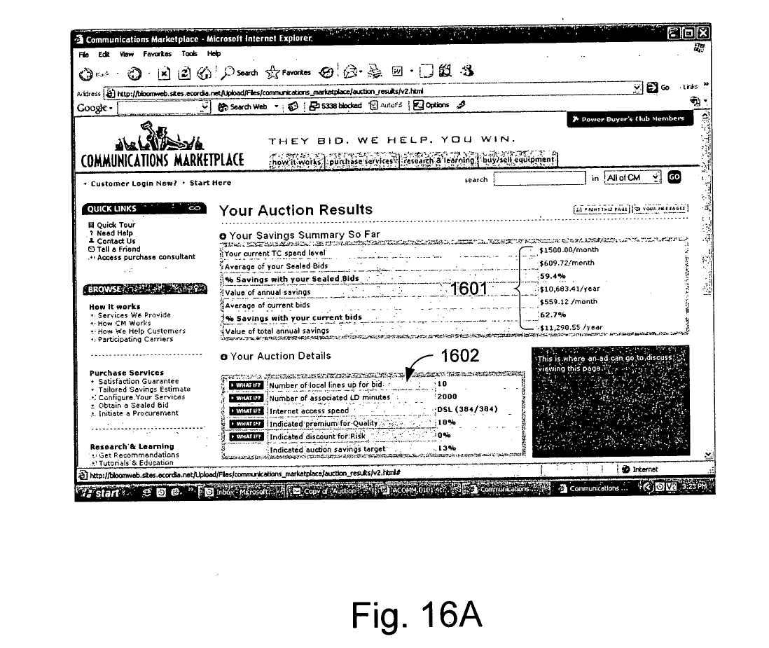

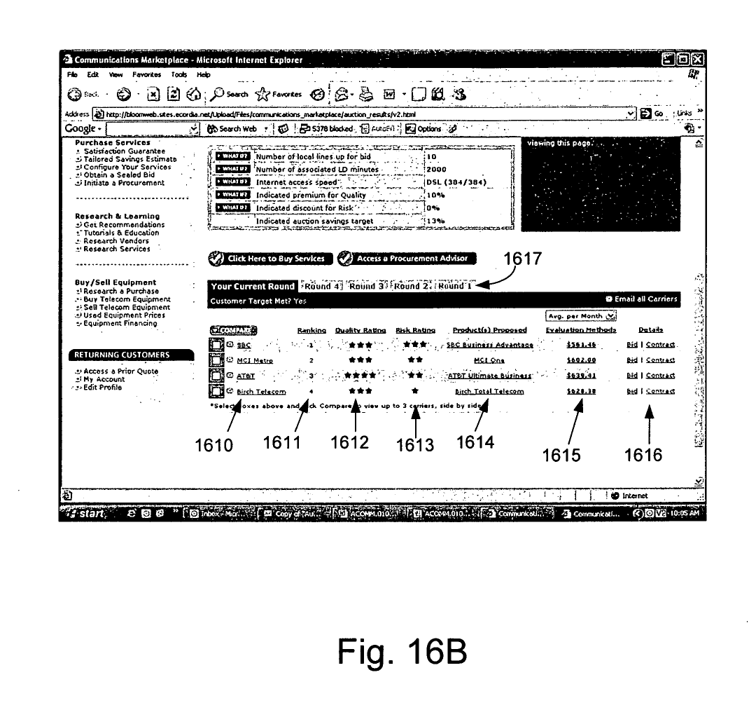

FIGS. 16A and 16B show screen shots of an ongoing reverse auction for telecommunications services in accordance with the present invention. The top of the web page in FIG. 16A displays a summary 1601 of the customer's savings as a result of the auction. The summary shows the savings from the sealed bid round as well as saving from the current round of interactive (if any).

The pictured web page also shows a summary of the auction details 1602. This includes the customer's requirements as well as the customer's risk and quality preferences and savings target.

FIG. 16B shows the bottom of the web page where the results of the current bidding round are displayed. The bid results show the participating carriers 1610 listed in the order of the ranking 1611. The quality and risk ratings 1612, 1613 are also displayed for each bidder. The third and fourth ranked bids in the present example illustrate the principle of non-cardinal ranking employed by the present invention. Although the fourth ranked bidder has a lower bid than the third ranked bidder (i.e. $628.38/month vs. $639.41/month), it is ranked lower due to its lower quality and risk ratings.

The evaluated bids 1615 are presented in the form of a single figure of merit; in the present example, average cost per month. The customer may click on any of the evaluated bids 1615 to see how the single figure of merit was derived from the carrier's raw bid. The customer may also click on the details 1716 to view the input form submitted by the bidders.

The customer can also click on the specific product(s) being offered 1614 to view the product features in more detail.

While the customer viewing the auction can see the identity of the participating bidders 1610, the bidders themselves are only identified to each other by their respective quality and risk ratings 1612, 1613.

At the top of the auction summary are tabs 1617 that allow the customer to view the results of previously closed rounds.

As stated above, once the specified number of rounds is completed, the auction is closed and the customer is notified (by email) that final results are available for review.

Similar to the “customer side” of the auction, the bidder side of the auction (as described) is also multidimensional—however, the dimensions are different from those considered by the customer. Instead of being singularly focused on bid price, as bidders would be in a standard reverse auction, the bidders in this auction are weighing the interaction of bid prices, the characteristics implicating the fundamental “value” of the customer in question, and how they wish to competitively position themselves within a field of other bidders of known competitive characteristics (their risk and quality ratings, in this implementation).

Upon accessing the final results, the customer can review the outcome of the auction and review the details of any or all bids and the associated vendor contracts (which are retrieved from the system's database). The customer may also research specific vendors and the products proposed (or compare them side-by-side) and exchange emails (still anonymously) with any or all vendors to clarify aspects of the bids, or to ask questions the customer may view to be critical to making a decision. The customer can examine sensitivities of the bids and/or ranking to changes in the customer's input assumptions (volume or breakout of long distance minutes and number of local service lines) or the expressed quality and risk preferences (service features and contract terms, cannot be varied.) The customer can also review the comments of the auction service customer base relative to the performance of specific vendors.

The customer may also confer with auction service procurement advisors to discuss the results, seek counsel on a decision or to gain an explanation of auction responses which are flagged as not being “apples-to-apples”. Once the customer finalizes the selection of a winner (which can be any of the bidders, not necessarily the first-ranked bidder), the system discloses all of the customer's information to the selected winner and asks that they confirm their winning bid in a binding offer with associated contractual paperwork. Should the bidder decide, upon review of the identity and full records of the customer, to renege on its bid, a procurement advisor contacts the customer and a “replacement winner” is selected from the remaining bidders. The customer will execute contractual paperwork directly with the winning bidder, who will commence billing the customer for the contracted service upon installation.

Auction final results may be held for a specified time for customer review (e.g., 10 business days). During this period, the customer will receive several reminders that the auction results are available for review. At the end of the time period, if the customer has not reviewed the auction results, selected a winner and placed an order, the results are erased and the customer's credit card (presented earlier) is charged with a “balk fee”, which recovers some portion of the expenses of the auction and related activity.

During the processing of the customer's order and related contractual paperwork, a retail implementation manager (an individual who oversees and coordinates installation activity) will obtain copies of the customer's prior telephone service bills and calculate an “audited savings percentage” against the pricing of the replacement service. This “audited savings percentage” is entered into the final auction record and the record is transferred into a historical results database.

This historical results database is continuously analyzed to enhance core system functions, including updating the results database used for the “Quick Savings Estimates”; driving the continuous review of the multivariate regressions utilized to provide “Tailored Savings Estimates” to customers; and keeping current the database used for the “expected further savings” projections presented to customers with their “Sealed Bids” to indicate the potential additional savings achievable by moving forward to an interactive auction.

The historical results database is also used to update the “carrier performance” database. One of the benefits to carriers who participate in the auction service is to receive insightful analysis of auction results, their competitive performance, and customer behavior. Some of the performance analyses available to active carrier participants include:
Win/loss ratios on bids,
Win/loss by product,
Win/loss by customers grouped by quality and risk preferences,
Win/loss by customers grouped by size and service category purchased,
Margin on wins (i.e. how much lower their winning bids were than the second place bid),
Margin on losses (i.e. how much higher their losing bids were than the winning bid), and
Win/Place/Show versus competitors by class (unique combinations of Quality rating and Risk rating)

These analyses enable carriers to refine their bidding strategies, better understand buyer behavior and potentially undertake development of new products, features, or pricing strategies that are more competitive in this electronic marketplace.

The fact that the auction system has “perfect knowledge” of competitive outcomes, prices, and customer behavior allows carrier participants to receive feedback and analyses of their performance which are not available to them in the “real world”. In the real world, the details of competitive bids and customer decisions are typically not available, or if available, are always tainted by imperfect knowledge and the desire of salesmen and customers to disguise some of the actual details of the outcome. Participation in this electronic marketplace can provide carriers with valuable tactical market intelligence useful in their business outside of their participation in reverse auctions.

In addition to multi-round auctions, the present invention may also be applied to simpler single-response procurement. A customer may send out a Request for Proposal (RFP) to a known list of suppliers and ask respondents to submit their quotations on-line, in an agreed-upon format. The system automatically creates a value-ranked tabulation of the responding bidders. This approach is particularly effective if bid evaluation is relatively simple, as in the case of semi-commodity purchases. For example, when purchasing industrial chemicals from overseas suppliers, a quality rating would reflect the quality of the commodity supplied (e.g., its purity or strength), and the risk rating could reflect on-time delivery risk (i.e. a shipment overland by train might be more likely to arrive on time than a sea-borne shipment). Alternatively, the risk rating could attempt to capture currency risk for purchases made in a foreign currency (i.e. buying from a country with a volatile currency would be riskier than a transaction done in US dollars).

The description of the present invention has been presented for purposes of illustration and description, and is not intended to be exhaustive or limited to the invention in the form or specific implementation (i.e. telecommunications) disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated. It will be understood by one of ordinary skill in the art that numerous variations will be possible to the disclosed embodiments without going outside the scope of the invention as disclosed in the claims.

We claim:

1. A method for automated proxy bidding in an auction, comprising the computer implemented steps of:
(a) defining a desired bid position relative to competing bids based on qualitative ratings associated with competing bidders; and
(b) submitting a bid related to a product.

2. The method according to claim 1, further comprising:
(c) retrieving competing bids related to said product and the qualitative ratings associated with each competing bidder;
(d) determining if the submitted bid achieves the desired bid position relative to the competing bids; and
(e) if the submitted bid does not achieve the desired bid position relative to the competing bids, adjusting the submitted bid according to a predefined sequence of bid moves.

3. The method according to claim 2, wherein the predefined sequence of bid moves defines specifically what changes are to be made to each individual price element of the product in question.

4. The method according to claim 2, wherein the predefined sequence of bid moves is modified according to specific customer characteristics.

5. The method according to claim 4, wherein more bid moves are used for customers with more favorable characteristics according to predefined standards.

6. The method according to claim 4, wherein less bid moves are used for customers with less favorable characteristics according to predefined standards.

7. The method according to claim 2, wherein the predefined sequence of bid moves is modified based in which round it is in the auction, wherein the full set of predetermined bid moves is not available before a specified auction round.

8. The method according to claim 1, wherein the desired bid position in step (a) has a specified premium relative to competing bidders with comparable or lower qualitative ratings.

9. The method according to claim 1, wherein the desired bid position in step (a) has a specified discount relative to competing bidders with comparable or higher qualitative ratings.

10. The method according to claim 2, wherein bidding may switch to manual bidding if the pre-defined sequence of bid moves does not achieve the desired relative bid position.

11. A computer program product in a computer readable medium for automated proxy bidding in an auction, computer program product comprising:
(a) first instructions for defining a desired bid position relative to competing bids based on qualitative ratings associated with competing bidders; and
(b) second instructions for submitting a bid related to a product.

12. The computer program product according to claim 11, further comprising:
(c) third instructions for retrieving competing bids related to said product and the qualitative ratings associated with each competing bidder;
(d) fourth instructions for determining if the submitted bid achieves the desired bid position relative to the competing bids; and
(e) fifth instructions for adjusting the submitted bid according to a predefined sequence of bid moves if the submitted bid does not achieve the desired bid position relative to the competing bids.

13. The computer program product according to claim 12, wherein the predefined sequence of bid moves defines specifically what changes are to be made to each individual price element of the product in question.

14. The computer program product according to claim 12, wherein the predefined sequence of bid moves is modified according to specific customer characteristics.

15. The computer program product according to claim 14, wherein more bid moves are used for customers with more favorable characteristics according to predefined standards.

16. The computer program product according to claim 14, wherein less bid moves are used for customers with less favorable characteristics according to predefined standards.

17. The computer program product according to claim 12, wherein the predefined sequence of bid moves is modified based in which round it is in the auction, wherein the full set of predetermined bid moves is not available before a specified auction round.

17. The computer program product according to claim 11, wherein the desired bid position in step (a) has a specified premium relative to competing bidders with lower qualitative ratings.

18. The computer program product according to claim 11, wherein the desired bid position in step (a) has a specified discount relative to competing bidders with comparable and higher qualitative ratings.

19. The computer program product according to claim 12, wherein bidding may switch to manual bidding if the pre-defined sequence of bid moves does not achieve the desired relative bid position.

20. A system for automated proxy bidding in an auction, comprising:
(a) means for defining a desired bid position relative to competing bids based on qualitative ratings associated with competing bidders; and
(b) means for submitting a bid related to a product.

21. The system according to claim 20, further comprising:
(c) means for retrieving competing bids related to said product and the qualitative ratings associated with each competing bidder;
(d) means for determining if the submitted bid achieves the desired bid position relative to the competing bids; and
(e) means for adjusting the submitted bid according to a predefined sequence of bid moves if the submitted bid does not achieve the desired bid position relative to the competing bids.

22. The system according to claim 20, wherein the desired bid position has a specified premium relative to competing bidders with lower qualitative ratings.

23. The system according to claim 20, wherein the desired bid position has a specified discount relative to competing bidders with comparable and higher qualitative ratings.
